(19) United States
(12) Patent Application Publication
(10) Pub. No.: US 2025/0039868 A1
(43) Pub. Date: Jan. 30, 2025

(54) Systems and Methods for Multi-PUSCH Configured Grant

(71) Applicant: Apple Inc., Cupertino, CA (US)

(72) Inventors: Ping-Heng Kuo, London (GB); Ralf Rossbach, Munich (DE); Weidong Yang, San Diego, CA (US)

(21) Appl. No.: 18/654,350

(22) Filed: May 3, 2024

Related U.S. Application Data
(60) Provisional application No. 63/515,637, filed on Jul. 26, 2023.

(51) Int. Cl. H04W 72/1268; H04L 1/1822; H04W 72/21; H04W 72/52

(52) U.S. Cl. CPC H04W 72/1268; H04L 1/1822; H04W 72/21; H04W 72/52

(57) ABSTRACT

Transmission occasions in a multi-PUSCH CG cycle can be identified as unused transmission occasions (UTOs) or used transmission occasions. HARQ PIDs for transmission occasions of the multi-PUSCH CG cycle can be determined prior to processing the first PUSCH. UTOs among all transmission occasions of the multi-PUSCH CG cycle can be determined based on a CG timer associated with the HARQ PIDs, status of a logical channel buffer associated with the multi-PUSCH CG, and prioritization of additional grants. HARQ PIDs can be remapped or changed to no longer be blocked by the CG timer. Overlapping transmission occasions of other grants may or may not be prioritized based on whether they overlap with multi-PUSCH CG transmission occasions already identified as UTOs. The use status of the transmission occasions can be reevaluated when certain conditions are met. Base stations can automatically refrain from decoding multi-PUSCH CG transmission occasions blocked by a CG timer.

### PRIORITY CLAIM

This application claims benefit of priority of U.S. Provisional Patent Application Ser. No. 63/515,637 titled “Systems and Methods for Multi-PUSCH Configured Grant”, filed on Jul. 26, 2023, and which is hereby incorporated by reference as though fully and completely set forth herein.

### BACKGROUND

The present application relates to wireless communications, including uplink communications performed according to multi-PUSCH Configured Grants, e.g., during 5G NR communications.

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS) and are capable of operating sophisticated applications that utilize these functionalities. Additionally, there exist numerous different wireless communication technologies and standards. Some examples of wireless communication standards include LTE, LTE Advanced (LTE-A), IEEE 802.11 (WLAN or Wi-Fi), IEEE 802.16 (WiMAX), IEEE 802.15 (Ultra-Wideband, UWB), BLUETOOTH™ etc. A current telecommunications standard moving beyond previous standards is called 5th generation mobile networks or 5th generation wireless systems, referred to as 3GPP NR (otherwise known as 5G-NR or NR-5G for 5G New Radio, also simply referred to as NR). NR proposes a higher capacity for a higher density of mobile broadband users, also supporting device-to-device, ultra-reliable, and massive machine communications, as well as lower latency and lower battery consumption, than LTE standards.

One aspect of wireless communications, e.g., NR cellular wireless communications, is switching between uplink communications and downlink communications, or between transmitting signals and receiving signals, by a wireless communication device/user equipment device (UE.) Uplink communications of a device take place using specific resources, including time and frequency resources, collectively referred to as radio resources, typically allocated/assigned to the UE by a serving base station. Efficient scheduling of uplink communications presents a constant challenge, for example for providing Extended Reality services.

### SUMMARY

Embodiments are presented herein of, inter alia, of methods and procedures for determining unused transmission occasions in a multi-PUSCH (multi-physical-uplink-shared-channel) configured grant (CG) during wireless cellular communications, for example during 3GPP New Radio (NR) communications. Embodiments are further presented herein for wireless communication systems containing at least wireless communication devices or user equipment devices (UEs) and/or base stations communicating with each other within the wireless communication systems.

Transmission occasions in a multi-PUSCH CG cycle can be identified as either an unused transmission occasion (UTO)/invalid PUSCH transmission occasion (ITO), or a used transmission occasion. Two overall approaches may be considered for identifying UTOs/ITOs among all transmission occasions of a multi PUSCH CG cycle. According to a first overall approach, a UE can first determine the hybrid automatic repeat request process identifiers (HARQ PIDs) for one or more transmission occasions of a multi-PUSCH CG, then identify the UTOs, as applicable. According to a second overall approach, the UE can first identify the UTOs of a multi-PUSCH CG (cycle), as applicable, then determine the HARQ PIDs for one or more of the transmission occasions of the multi-PUSCH CG (cycle.) Various proposals for characterizing and identifying transmission occasions of a multi-PUSCH CG (cycle) may be considered under the umbrella of the first approach and/or the second approach.

In view of the above, HARQ PIDs for one or more transmission occasions of a multi PUSCH CG cycle can be determined prior to processing the first PUSCH of the multi-PUSCH CG cycle. UTOs/ITOs among the transmission occasions of the multi-PUSCH CG cycle can be determined based on the status of one or more CG timers associated with the HARQ PIDs, status of a logical channel buffer associated with the multi-PUSCH CG, and prioritization of additional grants. In some cases, HARQ PIDs can be remapped or changed to no longer be blocked by a respective CG timer(s). Overlapping transmission occasions of other grants may be prioritized based on whether they overlap with multi-PUSCH CG transmission occasions already identified as UTOs/ITOs. The use status of the transmission occasions can be reevaluated when certain conditions are met. Base stations can automatically refrain from decoding multi-PUSCH CG transmission occasions blocked by a CG timer(s).

### HARQ PID Determination and UTO Determination Based on CG Timers

In some embodiments, a UE can determine corresponding HARQ PIDs for one or more PUSCH transmission occasions of a multi-PUSCH CG cycle prior to processing a first PUSCH transmission of the multi-PUSCH CG cycle, and can subsequently perform UL communications based at least on the determined one or more HARQ PIDs.

The UE can evaluate the status of CG timers associated with one or more of the determined corresponding HARQ PIDs and identify specific PUSCH transmission occasions among the one or more PUSCH transmission occasions as unused transmission occasions (UTOs) or invalid PUSCH transmission occasions (ITOs), based at least on the status of the CG timer. Evaluating the status of the CG timers can include determining that the specific PUSCH transmission occasions can be blocked by the CG timers running for the determined HARQ PIDs that correspond to the specific PUSCH transmission occasions.

In some embodiments, the UE can identify the UTOs and ITOs further based on a buffer status. This may include determining that a subset of remaining PUSCH transmission occasions of the multiple PUSCH transmission occasions not identified as UTOs or ITOs is required to accommodate data buffered in one or more logical channels (LCHs) allowed to use resource(s) of the subset of PUSCH transmission occasions and identifying PUSCH transmission occasions of the remaining PUSCH transmission occasions not included in the subset as UTOs or ITOs. The UE can transmit, to a base station, UTO uplink control information (UTO-UCI) that includes information that identifies the UTOs and/or ITOs to the base station and can perform the UL communications without using the UTOs and ITOs.

In some embodiments, the above procedures described herein can be performed by a media access control (MAC) entity in the UE, whereby the MAC entity can provide to a physical layer (PHY) in the UE the information that identifies the UTOs and/or ITOs, so that the UE can transmit the UTO-UCI accordingly.

### UTO Determination Based on Prioritization

In some embodiments, a UE can determine that a PUSCH transmission occasion of a multi-PUSCH CG cycle overlaps in time with a second transmission occasion, where the second transmission occasion has a higher priority relative to the PUSCH transmission occasion. The UE can then identify the PUSCH transmission occasion as UTO and/or ITO, based at least in response to determining that the second transmission occasion is to be performed. The UE can subsequently transmit, to a base station, UTO-UCI identifying the UTO and/or ITOs. The UE can use a MAC entity to perform these procedures, and the MAC entity may deliver, to the PHY of the UE, information that identifies the UTO and/or ITO. The UTO-UCI can then be determined based at least on the information provided to the PHY.

Determining that the second transmission occasion is to be performed can include determining that data to be transmitted via the second transmission occasion is present in a transmit buffer. The second transmission occasion can be a second PUSCH transmission occasion that is not part of the multi PUSCH CG cycle, or it can be a physical-uplink-control-channel (PUCCH) transmission occasion.

In some embodiments, the UE can transmit, to a base station, UTO-UCI indicating a PUSCH transmission occasion of a multi-PUSCH CG cycle as a used transmission occasion, and can determine that data to be transmitted via a second transmission occasion is present in a transmit buffer, where the second transmission occasion overlaps in time with the PUSCH transmission occasion and has a higher priority relative to the PUSCH transmission occasion.

The UE can accordingly deprioritize the PUSCH transmission occasion in response to determining that the data is present in the transmit buffer and can perform UL communications accordingly.

### Remapping of HARQ PID

In some embodiments, a UE can determine whether one or more PUSCH transmission occasions of a multi PUSCH CG cycle can be blocked by one or more CG timers running for HARQ PIDs that correspond to the one or more PUSCH transmission occasions, where the HARQ PIDs were determined based on a default method. The UE can switch or remap or change a respective HARQ PID corresponding to at least one of the one or more PUSCH transmission occasions to a respective alternate HARQ PID, in response to determining that the one or more PUSCH transmission occasions can be blocked by the one or more CG timers. The UE can perform UL communications based at least on the changed respective HARQ PID.

The UE can determine whether a HARQ PID corresponding to at least one of the one or more PUSCH transmission occasions is to be changed to a respective alternate HARQ PID, based at least on whether the at least one of the one or more PUSCH transmission occasions is already indicated to be an unused transmission occasion (UTO) and/or an invalid PUSCH transmission occasion (ITO). In some embodiments, the UE can repeat determining whether one or more HARQ PIDs can be blocked by running CG timer(s), a specified number, N>=1, times. Alternatively, the UE can continue determining whether one or more HARQ PIDs can be blocked by running CG timer(s) and changing/switching/remapping previously determined HARQ PIDs the until none of the determined corresponding HARQ PIDs associated with PUSCH transmission occasions of the one or more PUSCH transmission occasions not identified as UTOs and/or ITOs are blocked by a running CG timer.

Changing/switching/remapping the respective HARQ PID can include using a second method different from the default method. In some embodiments, the default method can include assigning a value to a first HARQ PID and obtaining each following HARQ PID by incrementing, by a specified value Y, an immediately preceding HARQ PID, until all of the corresponding HARQ PIDs have been determined. The second method can include obtaining the respective alternate HARQ PID by incrementing, by a specified value Y′ different from the specified value Y, an immediately preceding HARQ PID. The UE can indicate, to a base station, the specified value Y′.

Grant Prioritization with UTO Consideration

In some embodiments, a UE can determine that a first PUSCH transmission occasion corresponding to a first grant overlaps in time with a second PUSCH transmission occasion corresponding to a second grant and can further determine whether the second PUSCH transmission occasion has already been identified or indicated as a UTO. The UE may not deprioritize the first grant in response to determining that the second PUSCH transmission occasion has already been identified or indicated as a UTO. The second grant can be a multi-PUSCH CG.

### Event-Triggered UTO Update

In some embodiments, a UE can reevaluate the use status of a PUSCH transmission occasion of a multi-PUSCH CG cycle in response to any one or more of the following conditions:
a portion of data buffered in at least one logical channel (LCH) being discarded;
all data buffered in the LCH being discarded;
an amount of discarded data in LCH satisfying a threshold value;
an amount of remaining data in the LCH, after discarding data from the LCH, satisfying a threshold value;
a portion of data buffered in the LCH being multiplexed into another transmission resource;
all data buffered in the LCH being multiplexed into another transmission resource;
an amount of data in the LCH multiplexed into another transmission resource satisfying a threshold value;
an amount of remaining data in the LCH, after a portion of the data in the LCH has been multiplexed into another transmission resource, satisfying a threshold value;
a remaining time until expiration of a discard timer or expiration of a delivery deadline for data in the LCH satisfying a threshold value;
a determination that some radio resources may not be used because of:
   a CG timer associated with a HARQ process of a CG PUSCH occasion can be running when the CG PUSCH occasion is to occur or is to be processed;
   a CG PUSCH being deprioritized based on another transmission partially overlapping in time with the CG PUSCH.
      The UE can perform UL communications according to the reevaluated use status of the PUSCH transmission occasion. Reevaluating the use status of the PUSCH transmission occasion can include changing the use status from “used” to “unused”. The LCH can be restricted to be mapped to radio resources of a CG configuration of the multi-PUSCH CG.

### CG Timer-Aware Base Station Operations

In some embodiments, a base station can receive UTO-UCI carrying information indicating that a transmission occasion is to be used by a UE. The base station can determine whether a CG timer associated with a HARQ of the transmission occasion may be running when the transmission occasion is to be used or processed, and can decode the transmission occasion at least in response to determining that the CG timer may not be running, or not decode the transmission occasion and reallocate radio resources associated with the transmission occasion to another UE, at least in response to determining that the CG timer may be running.

Note that the techniques described herein can be implemented in and/or used with a number of different types of devices, including but not limited to, base stations, access points, cellular phones, portable media players, tablet computers, wearable devices, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

FIG. 1 illustrates an example of a simplified wireless communication system, according to some embodiments;

FIG. 2 illustrates an example base station in communication with an example wireless user equipment (UE) device, according to some embodiments;

FIG. 3 illustrates an example block diagram of a UE, according to some embodiments;

FIG. 4 illustrates an example block diagram of a base station, according to some embodiments;

FIG. 5 shows an example simplified block diagram illustrative of cellular communication circuitry, according to some embodiments;

FIG. 6 shows an example timing diagram illustrating packet traffic with a packet arrival rate of ‘1/T’;

FIG. 7 shows an example timing diagram illustrating preconfigured resource allocation with a periodicity of ‘T’;

FIG. 8 shows an example diagram illustrating respective packets belonging to corresponding video frames of a video stream;

FIG. 9 shows an example diagram illustrating an example of a configured grant (CG) with multiple PUSCH occasions per CG cycle;

FIG. 10 shows an example timing diagram illustrating CG cycles where UTO-UCI is provided to the base station by the UE;

FIG. 11 shows an example diagram illustrating transmission occasions that cannot be used by a UE due to a running CG timer;

FIG. 12 shows an example diagram illustrating a high-priority grant taking precedence over a low-priority grant;

FIG. 13 shows an example timing diagram illustrating an unnecessarily deprioritized grant (low-priority grant) having resources that overlap with multi-PUSCH CG transmission occasions that have already been identified as UTOs;

FIG. 14 shows an example timing diagram illustrating transmission occasions of a multi-PUSCH CG during which the target is carrying lower priority data, with transmission occasions that overlap with transmission occasion(s) of a different, higher-priority grant not being used;

FIG. 15 shows an example timing diagram with four transmission occasions of a multi-PUSCH CG during which the target is carrying lower priority data, with the use status of transmission occasions that overlap with transmission occasion(s) of a different, higher-priority grant to be determined;

FIG. 16 shows an example flow diagram for wireless communications during which the transmission status of PUSCH transmission occasions of a multi-PUSCH CG cycle is determined based at least on a CG timer, according to some embodiments;

FIG. 17 shows an example flow diagram for wireless communications during which the transmission status of PUSCH transmission occasions of a multi-PUSCH CG cycle is determined based at least on grant prioritization, according to some embodiments;

FIG. 18 shows an example flow diagram for wireless communications during which the transmission status of PUSCH transmission occasions of a multi-PUSCH CG cycle is determined based at least on grant prioritization, and a PUSCH transmission occasion of the multi-PUSCH CG cycle is deprioritized, according to some embodiments;

FIG. 19 shows an example flow diagram for wireless communications during which at least one HARQ PID associated with a PUSCH transmission occasion of a multi-PUSCH CG cycle is modified, according to some embodiments;

FIG. 20 shows an example flow diagram for wireless communications during which uplink grants are prioritized by considering the transmission status of PUSCH transmission occasions of a multi-PUSCH CG cycle, according to some embodiments; and

FIG. 21 shows an example flow diagram for wireless communications during which a base station can decode or not decode PUSCH transmission occasions of a multi-PUSCH CG cycle based at least on the status of one or more CG timers associated with the PUSCH transmission occasions, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION OF THE EMBODIMENTS

### Acronyms

Various acronyms are used throughout the present application. Definitions of the most prominently used acronyms that may appear throughout the present application are provided below:
5GMM: 5G Mobility Management
AC: Application Client
AF: Application Function
AMF: Access and Mobility Management Function
AMR: Adaptive Multi-Rate
AP: Access Point
APN: Access Point Name
APR: Applications Processor
BS: Base Station
BSF: Binding Support Function
BSSID: Basic Service Set Identifier
CA: Carrier Aggregation
CE: Control Element
CBG: Code Block Group
CBRS: Citizens Broadband Radio Service
CBSD: Citizens Broadband Radio Service Device
CBW: Channel Bandwidth
CCA: Clear Channel Assessment
CMR: Change Mode Request
CORESET: Control Resource Set
CS: Circuit Switched
CSI: Channel State Information
DC: Dual Connectivity
DCI: Downlink Control Information
DL: Downlink (from BS to UE)
DMRS: Demodulation Reference Signal
DN: Data Network
DNN: Data Network Name
DSDS: Dual SIM Dual Standby
DYN: Dynamic
E-UTRA: Evolved UTRA
EDCF: Enhanced Distributed Coordination Function
EN-DC: E-UTRA NR Dual Connectivity
ETSI: European Telecommunications Standards Institute
FDD: Frequency Division Duplexing
FT: Frame Type
GAA: General Authorized Access
GPSI: Generic Public Subscription Identifier
GPRS: General Packet Radio Service
GSM: Global System for Mobile Communication
GTP: GPRS Tunneling Protocol
HARQ: Hybrid Automatic Repeat Request
HPLMN: Home Public Land Mobile Network
ICBM: Inter-Cell Beam Management
Ich: Intra-Channel
IMS: Internet Protocol Multimedia Subsystem
IoT: Internet of Things
IP: Internet Protocol
ITS: Intelligent Transportation Systems
LAN: Local Area Network
LBT: Listen Before Talk
LCID: Logical Channel ID
LCS: Location Services
LMF: Location Management Function
LPP: LTE Positioning Protocol
LQM: Link Quality Metric
LTE: Long Term Evolution
MAC: Media Access Control(ler)
MCC: Mobile Country Code
MCS: Modulation and Coding Scheme
MNO: Mobile Network Operator
MO-LR: Mobile Originated Location Request
MT-LR: Mobile-Terminated Location Request
NAT: Network Address Translation
NAS: Non-Access Stratum
NDI: New Data Indicator
NEF: Network Exposure Function
NF: Network Function
NG-RAN: Next Generation Radio Access Network
NID: Network Identifier
NMF: Network Identifier Management Function
NPN: Non-Public (cellular) Network
NR: New Radio
NRF: Network Repository Function
NSI: Network Slice Instance
NSSAI: Network Slice Selection Assistance Information
OFDM: Orthogonal Frequency Division Multiplex(ing)
OOC: Out Of Coverage
PAL: Priority Access Licensee
PBCH: Physical Broadcast Channel
PDCCH: Physical Downlink Control Channel
PDCP: Packet Data Convergence Protocol
PDN: Packet Data Network
PDSCH: Physical Downlink Shared Channel
PDU: Protocol Data Unit
PGW: PDN Gateway
PID: Process Identifier
PLMN: Public Land Mobile Network
ProSe: Proximity Services
PRS: Positioning Reference Signal
PSCCH: Physical Sidelink Control Channel
PSFCH: Physical Sidelink Feedback Channel
PSSCH: Physical Sidelink Shared Channel
PSD: Power Spectral Density
PSS: Primary Synchronization Signal
PT: Payload Type
PTRS: Phase Tracking Reference Signal
PUCCH: Physical Uplink Control Channel
PUSCH: Physical Uplink Shared Channel
QBSS: Quality of Service Enhanced Basic Service Set
QI: Quality Indicator
RA: Registration Accept
RAN: Radio Access Network
RAT: Radio Access Technology
RF: Radio Frequency
RLM: Radio Link Monitoring
RNTI: Radio Network Temporary Identifier
ROHC: Robust Header Compression
RR: Registration Request
RRC: Radio Resource Control
RRM: Radio Resource Management
RS: Reference Signal
RSRP: Reference Signal Receive Power
RTP: Real-time Transport Protocol
RV: Redundancy Version
RX: Reception/Receive
SAS: Spectrum Allocation Server
SCS: Subcarrier Spacing
SD: Slice Descriptor
SI: System Information
SIB: System Information Block
SID: System Identification Number
SIM: Subscriber Identity Module
SINR: Signal-To-Interference-Plus-Noise Ratio
SGW: Serving Gateway
SMF: Session Management Function
SNPN: Standalone Non-Public Network
SR: Scheduling Request
SRS: Sounding Reference Signal
SSB: Synchronization Signal Block
SSS: Secondary Synchronization Signal
SUPI: Subscription Permanent Identifier
TBS: Transport Block Size
TCP: Transmission Control Protocol
TDD: Time Division Duplex
TDRA: Time Domain Resource Allocation
TPC: Transmit Power Control
TRP: Transmission/Reception Point
TX: Transmission/Transmit
UAC: Unified Access Control
UDM: Unified Data Management
UDR: User Data Repository
UE: User Equipment
UI: User Input
UL: Uplink (from UE to BS)
UMTS: Universal Mobile Telecommunication System
UPF: User Plane Function
URLLC: Ultra-Reliable Low-Latency Communication
URM: Universal Resources Management
URSP: UE Route Selection Policy
USIM: User Subscriber Identity Module
UTO: Unused Transmission Occasion
UTRA: Universal Mobile Telecommunications System Terrestrial Radio Access
Wi-Fi: Wireless Local Area Network (WLAN) RAT based on the Institute of Electrical and Electronics Engineers' (IEEE) 802.11 standards
WLAN: Wireless LAN
ZP: Zero Power

### Terms

The following is a glossary of terms that may appear in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium can comprise other types of memory as well or combinations thereof. In addition, the memory medium can be located in a first computer system in which the programs are executed, or can be located in a second different computer system which connects to the first computer system over a network, such as the Internet. In the latter instance, the second computer system can provide program instructions to the first computer system for execution. The term “memory medium” can include two or more memory mediums which can reside in different locations, e.g., in different computer systems that are connected over a network. The memory medium can store program instructions (e.g., embodied as computer programs) that can be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—Includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks can range from fine grained (combinatorial logic or look up tables) to coarse grained (arithmetic logic units or processor cores). A programmable hardware element can also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which perform wireless communications. Also referred to as wireless communication devices, many of which can be mobile and/or portable. Examples of UE devices include mobile telephones or smart phones (e.g., iPhone™, Android™-based phones) and tablet computers such as iPad™, Samsung Galaxy™, etc., gaming devices (e.g. Sony PlayStation™, Microsoft XBox™, etc.), portable gaming devices (e.g., Nintendo DS™, PlayStation Portable™ Gameboy Advance™, iPod™), laptops, wearable devices (e.g. smart watch, smart glasses), PDAs, portable Internet devices, music players, data storage devices, or other handheld devices, unmanned aerial vehicles (e.g., drones) and unmanned aerial controllers, etc. Various other types of devices can fall into this category if they include Wi-Fi or both cellular and Wi-Fi communication capabilities and/or other wireless communication capabilities, for example over short-range radio access technologies (SRATs) such as BLUETOOTH™, etc. In general, the term “UE” or “UE device” can be broadly defined to encompass any electronic, computing, and/or telecommunications device (or combination of devices) which is capable of wireless communication and can also be portable/mobile.

Wireless Device (or wireless communication device)—any of various types of computer systems devices which performs wireless communications using WLAN communications, SRAT communications, Wi-Fi communications and the like. As used herein, the term “wireless device” can refer to a UE device, as defined above, or to a stationary device, such as a stationary wireless client or a wireless base station. For example, a wireless device can be any type of wireless station of an 802.11 system, such as an access point (AP) or a client station (UE), or any type of wireless station of a cellular communication system communicating according to a cellular radio access technology (e.g., 5G NR, LTE), such as a base station or a cellular telephone, for example.

Communication Device—any of various types of computer systems or devices that perform communications, where the communications can be wired or wireless. A communication device can be portable (or mobile) or can be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processor—refers to various elements (e.g. circuits) or combinations of elements that are capable of performing a function in a device, e.g. in a user equipment device or in a cellular network device. Processors can include, for example: general purpose processors and associated memory, portions or circuits of individual processor cores, entire processor cores or processing circuit cores, processing circuit arrays or processor arrays, circuits such as ASICs (Application Specific Integrated Circuits), programmable hardware elements such as a field programmable gate array (FPGA), as well as any of various combinations of the above.

Channel—a medium used to convey information from a sender (transmitter) to a receiver. It should be noted that since characteristics of the term “channel” can differ according to different wireless protocols, the term “channel” as used herein can be considered as being used in a manner that is consistent with the standard of the type of device with reference to which the term is used. In some standards, channel widths can be variable (e.g., depending on device capability, band conditions, etc.). For example, LTE can support scalable channel bandwidths from 1.4 MHz to 20 MHz. In contrast, WLAN channels can be 22 MHz wide while Bluetooth channels can be 1 Mhz wide. Other protocols and standards can include different definitions of channels. Furthermore, some standards can define and use multiple types of channels, e.g., different channels for uplink or downlink and/or different channels for different uses such as data, control information, etc.

Band (or Frequency Band)—The term “band” has the full breadth of its ordinary meaning, and at least includes a section of spectrum (e.g., radio frequency spectrum) in which channels are used or set aside for the same purpose. Furthermore, “frequency band” is used to denote any interval in the frequency domain, delimited by a lower frequency and an upper frequency. The term can refer to a radio band or an interval of some other spectrum. A radio communications signal can occupy a range of frequencies over which (or where) the signal is carried. Such a frequency range is also referred to as the bandwidth of the signal. Thus, bandwidth refers to the difference between the upper frequency and lower frequency in a continuous band of frequencies. A frequency band can represent one communication channel or it can be subdivided into multiple communication channels. Allocation of radio frequency ranges to different uses is a major function of radio spectrum allocation. For example, in 5G NR, the operating frequency bands are categorized in two groups. More specifically, per 3GPP Release 15, frequency bands are designated for different frequency ranges (FR) and are defined as FR1 and FR2, with FR1 encompassing the 410 MHz-7125 MHz range and FR2 encompassing the 24250 MHz-52600 MHz range.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” contrasts with an operation being manually performed or specified by the user, where the user provides input to directly perform the operation. An automatic procedure can be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system can update the form in response to the user actions. The form can be automatically filled out by the computer system where the computer system (e.g., software executing on the computer system) analyzes the fields of the form and fills in the form without any user input specifying the answers to the fields. As indicated above, the user can invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately can refer to a value that is within 1 to 10 percent of the exact (or desired) value. It should be noted, however, that the actual threshold value (or tolerance) can be application dependent. For example, in some embodiments, “approximately” can mean within 0.1% of some specified or expected value, while in various other embodiments, the threshold can be, for example, 2%, 3%, 5%, and so forth, in accordance with the particular application.

Concurrent—refers to parallel execution or performance, where tasks, processes, or programs are performed in an at least partially overlapping manner. For example, concurrency can be implemented using “strong” or strict parallelism, where tasks are performed (at least partially) in parallel on respective computational elements, or using “weak parallelism”, where the tasks are performed in an interleaved manner, e.g., by time multiplexing of execution threads.

Station (STA)—The term “station” herein refers to any device that has the capability of communicating wirelessly, e.g. by using the 802.11 protocol. A station can be a laptop, a desktop PC, PDA, access point or Wi-Fi phone or any type of device similar to a UE. An STA can be fixed, mobile, portable, or wearable. Generally, in wireless networking terminology, a station (STA) broadly encompasses any device with wireless communication capabilities, and the terms station (STA), wireless client (UE) and node (BS) are therefore often used interchangeably.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Transmission Scheduling—Refers to the scheduling of transmissions, such as wireless transmissions. In some implementations of cellular radio communications, signal and data transmissions can be organized according to designated time units of specific duration during which transmissions take place. As used herein, the term “slot” has the full extent of its ordinary meaning, and at least refers to a smallest (or minimum) scheduling time unit in wireless communications. For example, in 3GPP LTE, transmissions are divided into radio frames, each radio frame being of equal (time) duration (e.g., 10 ms). A radio frame in 3GPP LTE can be further divided into a specified number of (e.g., ten) subframes, each subframe being of equal time duration, with the subframes designated as the smallest (minimum) scheduling unit, or the designated time unit for a transmission. Thus, in a 3GPP LTE example, a “subframe” can be considered an example of a “slot” as defined above. Similarly, a smallest (or minimum) scheduling time unit for 5G NR (or NR, for short) transmissions is referred to as a “slot”. In different communication protocols the smallest (or minimum) scheduling time unit can also be named differently.

Resources—The term “resource” has the full extent of its ordinary meaning and can refer to frequency resources and time resources used during wireless communications. As used herein, a resource element (RE) refers to a specific amount or quantity of a resource. For example, in the context of a time resource, a resource element can be a time period of specific length. In the context of a frequency resource, a resource element can be a specific frequency bandwidth, or a specific amount of frequency bandwidth, which can be centered on a specific frequency. As one specific example, a resource element can refer to a resource unit of 1 symbol (in reference to a time resource, e.g. a time period of specific length) per 1 subcarrier (in reference to a frequency resource, e.g. a specific frequency bandwidth, which can be centered on a specific frequency). A resource element group (REG) has the full extent of its ordinary meaning and at least refers to a specified number of consecutive resource elements. In some implementations, a resource element group may not include resource elements reserved for reference signals. A control channel element (CCE) refers to a group of a specified number of consecutive REGs. A resource block (RB) refers to a specified number of resource elements made up of a specified number of subcarriers per specified number of symbols. Each RB can include a specified number of subcarriers. A resource block group (RBG) refers to a unit including multiple RBs. The number of RBs within one RBG can differ depending on the system bandwidth.

Bandwidth Part (BWP)—A carrier bandwidth part (BWP) is a contiguous set of physical resource blocks selected from a contiguous subset of the common resource blocks for a given numerology on a given carrier. For downlink, a UE can be configured with up to a specified number of carrier BWPs (e.g. four BWPs, per some specifications), with one BWP per carrier active at a given time (per some specifications). For uplink, the UE can similarly be configured with up to several (e.g. four) carrier BWPs, with one BWP per carrier active at a given time (per some specifications). If a UE is configured with a supplementary uplink, then the UE can be additionally configured with up to the specified number (e.g. four) carrier BWPs in the supplementary uplink, with one carrier BWP active at a given time (per some specifications).

Multi-cell Arrangements—A Master node is defined as a node (radio access node) that provides control plane connection to the core network in case of multi radio dual connectivity (MR-DC). A master node can be a master eNB (3GPP LTE) or a master gNB (3GPP NR), for example. A secondary node is defined as a radio access node with no control plane connection to the core network, providing additional resources to the UE in case of MR-DC. A Master Cell group (MCG) is defined as a group of serving cells associated with the Master Node, including the primary cell (PCell) and optionally one or more secondary cells (SCell). A Secondary Cell group (SCG) is defined as a group of serving cells associated with the Secondary Node, including a special cell, namely a primary cell of the SCG (PSCell), and optionally including one or more SCells. A UE can typically apply radio link monitoring to the PCell. If the UE is configured with an SCG then the UE can also apply radio link monitoring to the PSCell. Radio link monitoring is generally applied to the active BWPs and the UE is not required to monitor inactive BWPs. The PCell is used to initiate initial access, and the UE can communicate with the PCell and the SCell via Carrier Aggregation (CA). Currently Amended capability means a UE can receive and/or transmit to and/or from multiple cells. The UE initially connects to the PCell, and one or more SCells can be configured for the UE once the UE is in a connected state.

Core Network (CN)—Core network is defined as a part of a 3GPP system which is independent of the connection technology (e.g. the Radio Access Technology, RAT) of the UEs. The UEs can connect to the core network via a radio access network, RAN, which can be RAT-specific.

Downlink Control Information (DCI)—In 3GPP communications, DCI is transmitted to a mobile device or UE (e.g., by a serving base station in the network) and contains multiple different fields. Each field is used to configure one part or aspect of a scheduled communication(s) of the device. To put it another way, each field in the DCI can correspond to a specific communication parameter or parameters configuring a corresponding aspect of the scheduled communication(s) of the device. By decoding the DCI, the UE obtains all the configuring parameters or parameter values according to the fields in the DCI, thereby obtaining all the information about the scheduled communication(s) and subsequently performing the scheduled communication(s) according to those parameters/parameter values.

Extended Reality (XR)—an umbrella term for Virtual Reality (VR), Augmented Reality (AR), and Mixed Reality (MR). It is considered the next-generation computing platform which aims to create virtual experiences indistinguishable from reality. There are numerous XR experiences with applications in a variety of scenarios. Additional VR applications can include online gaming, virtual event participation, and educational experiences, while mobile AR use cases can include video gaming, mission critical services, online shopping, spatial-audio multiparty calls and conferences, and digital co-design.

Transport Block Size (TBS)—A transport block (TB), as used in 5G NR, refers to the payload which is passed between the MAC (media access control) layer and PHY (physical) layer, e.g., for shared data channels such as PDSCH (physical downlink shared channel) and PUSCH (physical uplink shared channel). A Transport Block undergoes PHY layer processing at the transmitter before being mapped onto the PDSCH for transmission via the over-the-air interface. The TBS typically depends on MCS (modulation coding scheme), number of used physical resource blocks, etc. Modulation order and code rate can be determined by tables, (as configured in the 3GPP specification) indexed based on DCI (downlink control information), C-RNTI (cell radio temporary network identifier), and MCS.

Uplink Control Information (UCI)—contains the hybrid automatic repeat request acknowledgment (HARQ-ACK), channel state information of a shared channel, and scheduling request (SR) for transmission of uplink data.

Configured Grant (CG)—can be considered an uplink version of semi-persistent scheduling (SPS). 5G NR defines the use of CG scheduling for uplink (UL) transmissions to eliminate the need to request and assign resources for each uplink packet transmission by pre-allocating uplink resources to the UE. Introduced in Rel-15 of the 3GPP specification.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

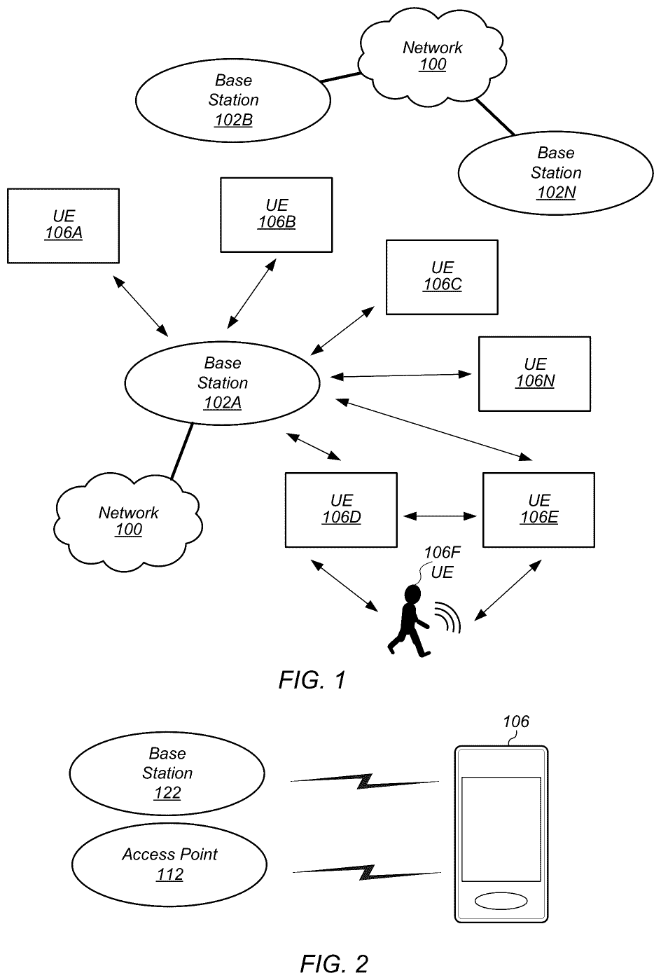

### FIGS. 1 and 2—Example Communication Systems

FIG. 1 illustrates an example of a simplified wireless communication system, according to some embodiments. It is noted that the system of FIG. 1 is merely one example of a possible system, and embodiments can be implemented in any of various systems, as desired.

As shown, the example wireless communication system includes base stations 102A through 102N, also collectively referred to as base station(s) 102 or base station 102. As shown in FIG. 1, base station 102A communicates over a transmission medium with one or more user devices 106A through 106N. Each of the user devices can be referred to herein as a “user equipment” (UE) or UE device. Thus, the user devices 106A through 106N are referred to as UEs or UE devices and are also collectively referred to as UE(s) 106 or UE 106.

The base station 102A can be a base transceiver station (BTS) or cell site and can include hardware that enables wireless communication with the UEs 106A through 106N. The base station 102A can also be equipped to communicate with a network 100 (e.g., a core network of a cellular service provider, a telecommunication network such as a public switched telephone network (PSTN), and/or the Internet, neutral host or various CBRS (Citizens Broadband Radio Service) deployments, among various possibilities). Thus, the base station 102A can facilitate communication between the user devices 106 and/or between the user devices 106 and the network 100. In particular, the cellular base station 102A can provide UEs 106 with various telecommunication capabilities, such as voice, short message service (SMS) and/or data services. The communication area (or coverage area) of the base station 106 can be referred to as a “cell.” It is noted that “cell” can also refer to a logical identity for a given wireless communication coverage area at a given frequency. In general, any independent cellular wireless coverage area can be referred to as a “cell”. In such cases a base station can be situated at confluences of three cells. The base station, in this uniform topology, can serve three 120 degree beam width areas referenced as cells. Also, in case of carrier aggregation, small cells, relays, etc. can each represent a cell. In carrier aggregation, primary cells and secondary cells can service at least partially overlapping coverage areas but on different respective frequencies. For example, a base station can serve any number of cells, and cells served by a base station may or may not be collocated (e.g., remote radio heads). As also used herein, from the perspective of UEs, a base station can sometimes be considered as representing the network insofar as uplink and downlink communications of the UE are concerned. Thus, a UE communicating with one or more base stations in the network can also be interpreted as the UE communicating with the network and can further also be considered at least a part of the UE communicating on the network or over the network.

The base station(s) 102 and the user devices 106 can be configured to communicate over the transmission medium using any of various radio access technologies (RATs), also referred to as wireless communication technologies, or telecommunication standards, such as LTE, LTE-Advanced (LTE-A), LAA/LTE-U, 5G-NR (NR, for short), Wi-Fi, Ultra Wideband, etc. Note that if the base station 102A is implemented in the context of LTE, it may alternately be referred to as an ‘eNodeB’ or ‘eNB’. Similarly, if the base station 102A is implemented in the context of 5G NR, it may alternately be referred to as ‘gNodeB’ or ‘gNB’. In some embodiments, the base station 102 (e.g. an eNB in an LTE network or a gNB in an NR network) can communicate with at least one UE having the capability to transmit reference signals according to various embodiments disclosed herein. Depending on a given application or specific considerations, for convenience some of the various RATs can be functionally grouped according to an overall defining characteristic. For example, all cellular RATs can be collectively considered as representative of a first (form/type of) RAT, while Wi-Fi communications can be considered as representative of a second RAT. In other cases, individual cellular RATs can be considered individually as different RATs. For example, when differentiating between cellular communications and Wi-Fi communications, “first RAT” can collectively refer to all cellular RATs under consideration, while “second RAT” can refer to Wi-Fi. Similarly, when applicable, different forms of Wi-Fi communications (e.g. over 2.4 GHz vs. over 5 GHz) can be considered as corresponding to different RATs. Furthermore, cellular communications performed according to a given RAT (e.g. LTE or NR) can be differentiated from each other based on the frequency spectrum in which those communications are conducted. For example, LTE or NR communications can be performed over a primary licensed spectrum as well as over a secondary spectrum such as an unlicensed spectrum and/or spectrum that was assigned to private networks. Overall, the use of various terms and expressions will always be clearly indicated with respect to and within the context of the various applications/embodiments under consideration.

As shown, the base station 102A can also be equipped to communicate with a network 100 (e.g., a core network of a cellular service provider, a telecommunication network such as a public switched telephone network (PSTN), and/or the Internet, among various possibilities).

Thus, the base station 102A can facilitate communication between the user devices 106 and/or between the user devices 106 and the network 100. In particular, the cellular base station 102A can provide UEs 106 with various telecommunication capabilities, such as voice, SMS and/or data services. UE 106 can be capable of communicating using multiple wireless communication standards. For example, a UE 106 might be configured to communicate according to any or all aspects of a 3GPP cellular communication standard (such as LTE or NR). Base station 102A and other similar base stations (such as base stations 102B . . . 102N) operating according to the same or a different cellular communication standard can thus be provided as one or more networks of cells, which can provide continuous or nearly continuous overlapping service to UE 106 and similar devices over a wide geographic area via one or more cellular communication standards.

Thus, while base station 102A can act as a “serving cell” for UEs 106A-106N as illustrated in FIG. 1, each one of UE(s) 106 may also be capable of receiving signals from (and can possibly be within communication range of) one or more other cells (possibly provided by base stations 102B-102N and/or any other base stations), which can be referred to as “neighboring cells”. Such cells can also be capable of facilitating communication in-between user devices 106 and/or between user devices 106 and the network 100. Such cells can include “macro” cells, “micro” cells, “pico” cells, and/or cells which provide any of various other granularities of service area size. For example, base stations 102A-102B illustrated in FIG. 1 can be macro cells, while base station 102N can be a micro cell. Other configurations are also possible.

In some embodiments, base station 102A can be a next generation base station, e.g., a 5G New Radio (5G NR) base station, or “gNB”. In some embodiments, a gNB can be connected to a legacy evolved packet core (EPC) network and/or to a NR core (NRC) network. In addition, a gNB cell can include one or more transmission and reception points (TRPs). In addition, a UE capable of operating according to 5G NR can be connected to one or more TRPs within one or more gNBs.

The UE 106 might also or alternatively be configured to communicate using WLAN, BLUETOOTH™, BLUETOOTH™ Low-Energy, one or more global navigational satellite systems (GNSS, e.g., GPS or GLONASS), one and/or more mobile television broadcasting standards (e.g., ATSC-M/H or DVB-H), etc. Other combinations of wireless communication standards (including more than two wireless communication standards) are also possible.

Furthermore, the UE 106 can also communicate with Network 100, through one or more base stations or through other devices, stations, or any appliances not explicitly shown but considered to be part of Network 100. UE 106 communicating with a network can therefore be interpreted as the UE(s) 106 communicating with one or more network nodes considered to be a part of the network and which may interact with the UE(s) 106 to conduct communications with the UE(s) 106 and in some cases affect at least some of the communication parameters and/or use of communication resources of the UE(s) 106.

As also illustrated in FIG. 1, at least some of the UEs, e.g., UEs 106D and 106E can represent vehicles communicating with each other and with base station 102, e.g., via cellular communications such as 3GPP LTE and/or 5G-NR communications, for example. In addition, UE 106F can represent a pedestrian who is communicating and/or interacting in a similar manner with the vehicles represented by UEs 106D and 106E. Various embodiments of vehicles communicating in a network exemplified in FIG. 1 are disclosed, for example, in the context of vehicle-to-everything (V2X) communications such as the communications specified by certain versions of the 3GPP standard, among others.

FIG. 2 illustrates an example user equipment 106 (e.g., one of UEs 106A through 106N) in communication with the base station 122 and an access point 112, according to some embodiments. The UE 106 can be a device with both cellular communication capability and non-cellular communication capability (e.g., BLUETOOTH™, Wi-Fi, and so forth) such as a mobile phone, a hand-held device, a computer, or a tablet, or virtually any type of wireless device. The UE 106 can include a processor that is configured to execute program instructions stored in memory. The UE 106 can perform any of the method embodiments described herein by executing such stored instructions. Alternatively, or in addition, the UE 106 can include a programmable hardware element such as an FPGA (field-programmable gate array) that is configured to perform any of the method embodiments described herein, or any portion of any of the method embodiments described herein. The UE 106 can be configured to communicate using any of multiple wireless communication protocols. For example, the UE 106 can be configured to communicate using two or more of LTE, LTE-A, NR, WLAN, or GNSS. Other combinations of wireless communication standards are also possible.

The UE 106 can include one or more antennas for communicating using one or more wireless communication protocols according to one or more RAT standards, e.g. those previously mentioned above. In some embodiments, the UE 106 can share one or more parts of a receive chain and/or transmit chain between multiple wireless communication standards.

The shared radio can include a single antenna, or can include multiple antennas (e.g., for MIMO) for performing wireless communications. Alternatively, the UE 106 can include separate transmit and/or receive chains (e.g., including separate antennas and other radio components) for each wireless communication protocol with which it is configured to communicate. As another alternative, the UE 106 can include one or more radios or radio circuitry which are shared between multiple wireless communication protocols, and one or more radios which are used exclusively by a single wireless communication protocol. For example, the UE 106 can include radio circuitries for communicating using LTE and/or NR and/or other cellular wireless communication protocols, and separate radios for communicating using each of Wi-Fi and BLUETOOTH™. Other configurations are also possible.

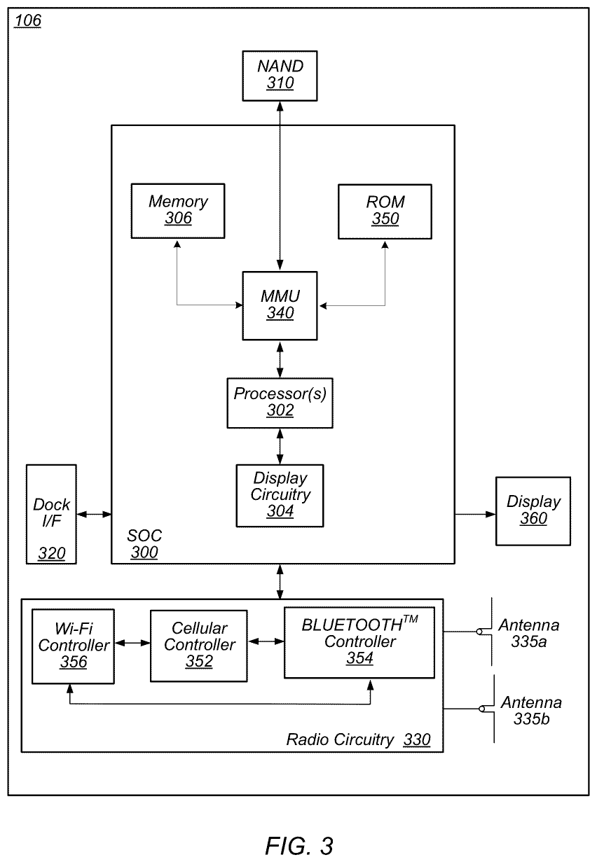

### FIG. 3—Block Diagram of an Example UE

FIG. 3 illustrates a block diagram of an example UE 106, according to some embodiments. As shown, the UE 106 can include a system on chip (SOC) 300, which can include various elements/components for various purposes. For example, as shown, the SOC 300 can include processor(s) 302 which can execute program instructions for the UE 106 and display circuitry 304 which can perform graphics processing and provide display signals to the display 360. The processor(s) 302 can also be coupled to memory management unit (MMU) 340, which can be configured to receive addresses from the processor(s) 302 and translate those addresses to locations in memory (e.g., memory 306, read only memory (ROM) 350, NAND flash memory 310) and/or to other circuits or devices, such as the display circuitry 304, radio circuitry 330, connector I/F 320, and/or display 360. The MMU 340 can be configured to perform memory protection and page table translation or set up. In some embodiments, the MMU 340 can be included as a portion of the processor(s) 302.

As shown, the SOC 300 can be coupled to various other circuits of the UE 106. For example, the UE 106 can include various types of memory (e.g., including NAND flash 310), a connector interface 320 (e.g., for coupling to the computer system), the display 360, and wireless communication circuitry (e.g., for LTE, LTE-A, NR, BLUETOOTH™, Wi-Fi, GPS, etc.). The UE device 106 can include at least one antenna (e.g. 335a), and possibly multiple antennas (e.g. illustrated by antennas 335a and 335b), for performing wireless communication with base stations and/or other devices. Antennas 335a and 335b are shown by way of example, and UE device 106 can include fewer or more antennas. Overall, the one or more antennas are collectively referred to as antenna(s) 335. For example, the UE device 106 can use antenna(s) 335 to perform the wireless communication with the aid of radio circuitry 330. As noted above, the UE can be configured to communicate wirelessly using multiple wireless communication standards in some embodiments.

As further described herein, the UE 106 (and/or base station 102) can include hardware and software components for implementing methods for at least UE 106 to transmit reference signals according to various embodiments disclosed herein. The processor(s) 302 of the UE device 106 can be configured to implement part or all of the methods described herein, e.g., by executing program instructions stored on a memory medium (e.g., a non-transitory computer-readable memory medium). In other embodiments, processor(s) 302 can be configured as a programmable hardware element, such as an FPGA (Field Programmable Gate Array), or as an ASIC (Application Specific Integrated Circuit). Furthermore, processor(s) 302 can be coupled to and/or can interoperate with other components as shown in FIG. 3, to implement communications by UE 106 to transmit reference signals according to various embodiments disclosed herein. Specifically, processor(s) 302 can be coupled to and/or can interoperate with other components as shown in FIG. 3 to facilitate UE 106 communicating in a manner that seeks to optimize RAT selection. Processor(s) 302 can also implement various other applications and/or end-user applications running on UE 106.

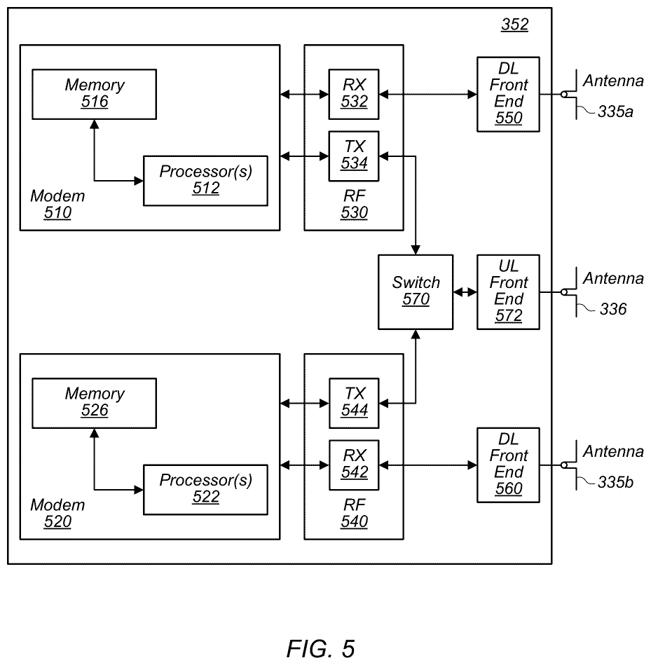

In some embodiments, radio circuitry 330 can include separate controllers dedicated to controlling communications for various respective RATs and/or RAT standards. For example, as shown in FIG. 3, radio circuitry 330 can include a Wi-Fi controller 356, a cellular controller (e.g. LTE and/or NR controller) 352, and BLUETOOTH™ controller 354, and according to at least some embodiments, one or more or all of these controllers can be implemented as respective integrated circuits (ICs or chips, for short) in communication with each other and with SOC 300 (e.g. with processor(s) 302). For example, Wi-Fi controller 356 can communicate with cellular controller 352 over a cell-ISM link or WCI interface, and/or BLUETOOTH™ controller 354 can communicate with cellular controller 352 over a cell-ISM link, etc. While three separate controllers are illustrated within radio circuitry 330, other embodiments can have fewer or more similar controllers for various different RATs and/or RAT standards that can be implemented in UE device 106. For example, at least one example block diagram illustrative of some embodiments of cellular controller 352 is shown in FIG. 5 and will be further described below.

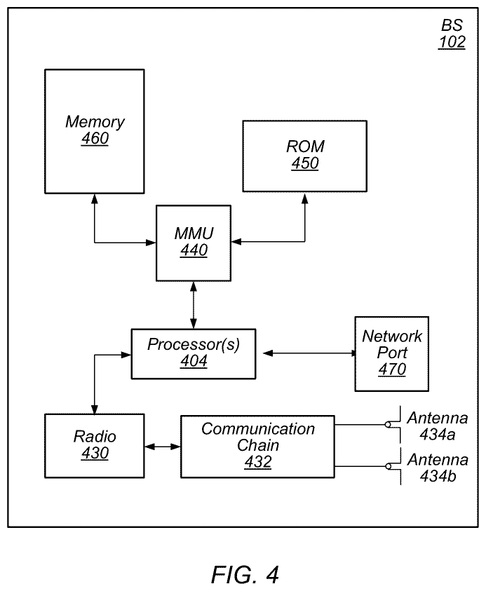

### FIG. 4—Block Diagram of an Example Base Station

FIG. 4 illustrates a block diagram of an example base station 102, according to some embodiments. It is noted that the base station of FIG. 4 is merely one example of a possible base station. As shown, the base station 102 can include processor(s) 404 which can execute program instructions for the base station 102. The processor(s) 404 can also be coupled to memory management unit (MMU) 440, which can be configured to receive addresses from the processor(s) 404 and translate those addresses to locations in memory (e.g., memory 460 and read only memory (ROM) 450) or to other circuits or devices.

The base station 102 can include at least one network port 470. The network port 470 can be configured to couple to a telephone network and provide a plurality of devices, such as UE devices 106, access to the telephone network as described above in FIGS. 1 and 2. The network port 470 (or an additional network port) can also or alternatively be configured to couple to a cellular network, e.g., a core network of a cellular service provider. The core network can provide mobility related services and/or other services to a plurality of devices, such as UE devices 106. In some cases, the network port 470 can couple to a telephone network via the core network, and/or the core network can provide a telephone network (e.g., among other UE devices serviced by the cellular service provider).

The base station 102 can include at least one antenna 434a, and possibly multiple antennas (e.g. illustrated by antennas 434a and 434b), for performing wireless communication with mobile devices and/or other devices. Antennas 434a and 434b are shown by way of example, and base station 102 can include fewer or more antennas. Overall, the one or more antennas, which can include antenna 434a and/or antenna 434b, are collectively referred to as antenna 434 or antenna(s) 434. Antenna(s) 434 can be configured to operate as a wireless transceiver and can be further configured to communicate with UE devices 106 via radio circuitry 430. The antenna(s) 434 communicates with the radio 430 via communication chain 432. Communication chain 432 can be a receive chain, a transmit chain or both. The radio circuitry 430 can be designed to communicate via various wireless telecommunication standards, including, but not limited to, LTE, LTE-A, 5G-NR (NR), etc. The processor(s) 404 of the base station 102 can be configured to implement part or all of the methods described herein, e.g., by executing program instructions stored on a memory medium (e.g., a non-transitory computer-readable memory medium). Alternatively, the processor(s) 404 can be configured as a programmable hardware element(s), such as an FPGA (Field Programmable Gate Array), or as an ASIC (Application Specific Integrated Circuit), or a combination thereof. In the case of certain RATs, for example Wi-Fi, base station 102 can be designed as an access point (AP), in which case network port 470 can be implemented to provide access to a wide area network and/or local area network (s), e.g. it can include at least one Ethernet port, and radio 430 can be designed to communicate according to the Wi-Fi standard.

### FIG. 5—Example Cellular Communication Circuitry

FIG. 5 illustrates simplified block diagram illustrative of an example cellular controller 352, according to some embodiments. It is noted that the block diagram of the cellular communication circuitry of FIG. 5 is only one example of a possible cellular communication circuit; other circuits, such as circuits including or coupled to sufficient antennas for different RATs to perform uplink activities using separate antennas, or circuits including or coupled to fewer antennas, e.g., that can be shared among multiple RATs, are also possible. According to some embodiments, cellular communication circuitry 352 can be included in a communication device, such as communication device 106 described above. As noted above, communication device 106 can be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 352 can couple (e.g., communicatively; directly or indirectly) to one or more antennas, such as antennas 335a-b and 336 as shown. In some embodiments, cellular communication circuitry 352 can include dedicated receive chains (including and/or coupled to (e.g., communicatively; directly or indirectly) dedicated processors and/or radios) for multiple RATs (e.g., a first receive chain for LTE and a second receive chain for 5G NR). For example, as shown in FIG. 5, cellular communication circuitry 352 can include a first modem 510 and a second modem 520. The first modem 510 can be configured for communications according to a first RAT, e.g., such as LTE or LTE-A, and the second modem 520 can be configured for communications according to a second RAT, e.g., such as 5G NR.

As shown, the first modem 510 can include one or more processors 512 and a memory 516 in communication with processors 512. Modem 510 can be in communication with a radio frequency (RF) front end 530. RF front end 530 can include circuitry for transmitting and receiving radio signals. For example, RF front end 530 can include receive circuitry (RX) 532 and transmit circuitry (TX) 534. In some embodiments, receive circuitry 532 can be in communication with downlink (DL) front end 550, which can include circuitry for receiving radio signals via antenna 335a.

Similarly, the second modem 520 can include one or more processors 522 and a memory 526 in communication with processors 522. Modem 520 can be in communication with an RF front end 540. RF front end 540 can include circuitry for transmitting and receiving radio signals. For example, RF front end 540 can include receive circuitry 542 and transmit circuitry 544. In some embodiments, receive circuitry 542 can be in communication with DL front end 560, which can include circuitry for receiving radio signals via antenna 335b.

In some embodiments, a switch 570 can couple transmit circuitry 534 to uplink (UL) front end 572. In addition, switch 570 can couple transmit circuitry 544 to UL front end 572. UL front end 572 can include circuitry for transmitting radio signals via antenna 336. Thus, when cellular communication circuitry 352 receives instructions to transmit according to the first RAT (e.g., as supported via the first modem 510), switch 570 can be switched to a first state that allows the first modem 510 to transmit signals according to the first RAT (e.g., via a transmit chain that includes transmit circuitry 534 and UL front end 572). Similarly, when cellular communication circuitry 352 receives instructions to transmit according to the second RAT (e.g., as supported via the second modem 520), switch 570 can be switched to a second state that allows the second modem 520 to transmit signals according to the second RAT (e.g., via a transmit chain that includes transmit circuitry 544 and UL front end 572).

As described herein, the first modem 510 and/or the second modem 520 can include hardware and software components for implementing any of the various features and techniques described herein. The processors 512, 522 can be configured to implement part or all of the features described herein, e.g., by executing program instructions stored on a memory medium (e.g., a non-transitory computer-readable memory medium). Alternatively (or in addition), processors 512, 522 can be configured as a programmable hardware element, such as an FPGA (Field Programmable Gate Array), or as an ASIC (Application Specific Integrated Circuit). Alternatively (or in addition) the processors 512, 522, in conjunction with one or more of the other components 530, 532, 534, 540, 542, 544, 550, 570, 572, 335 and 336 can be configured to implement part or all of the features described herein.

In addition, as described herein, processors 512, 522 can include one or more components. Thus, processors 512, 522 can include one or more integrated circuits (ICs) that are configured to perform the functions of processors 512, 522. In addition, each integrated circuit can include circuitry (e.g., first circuitry, second circuitry, etc.) configured to perform the functions of processors 512, 522.

In some embodiments, the cellular communication circuitry 352 can include only one transmit/receive chain. For example, the cellular communication circuitry 352 may not include the modem 520, the RF front end 540, the DL front end 560, and/or the antenna 335b. As another example, the cellular communication circuitry 352 may not include the modem 510, the RF front end 530, the DL front end 550, and/or the antenna 335a. In some embodiments, the cellular communication circuitry 352 may also not include the switch 570, and the RF front end 530 or the RF front end 540 can be in communication, e.g., directly, with the UL front end 572

XR Services with Periodic Traffic Patterns

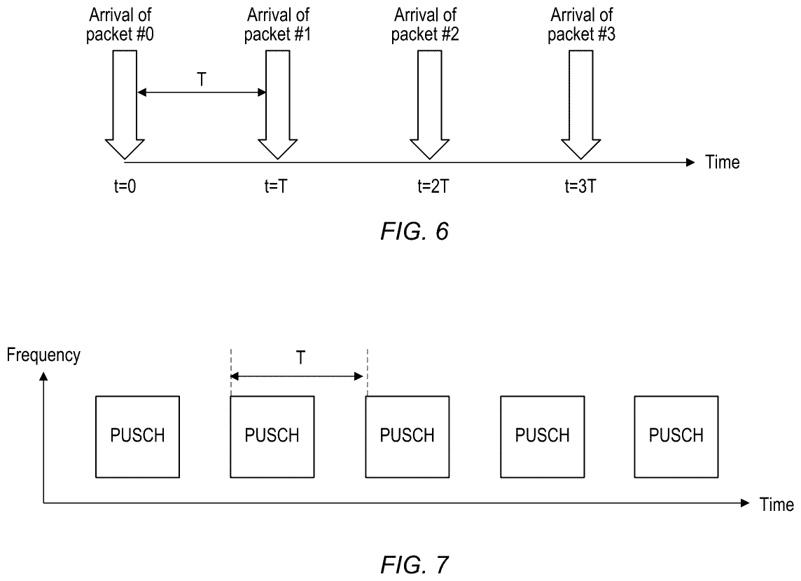

As previously mentioned, wireless communications, e.g., NR cellular wireless communications, include both uplink (UL) and downlink (DL) communications by a wireless communication device/user equipment device (UE.) In some cases, UL and DL communications can be part of data transmission (TX) and reception (RX) for Extended Reality (XR) services. For both downlink and uplink XR services, the (data) payload is typically periodical. For example, in case of video transmissions, a video stream can have various frame rates, e.g., it can have a video frame rate of 60 frames per second (fps), 90 fps, or 120 fps. An illustration of example periodic traffic with a packet arrival rate of 1/T is shown in FIG. 6.

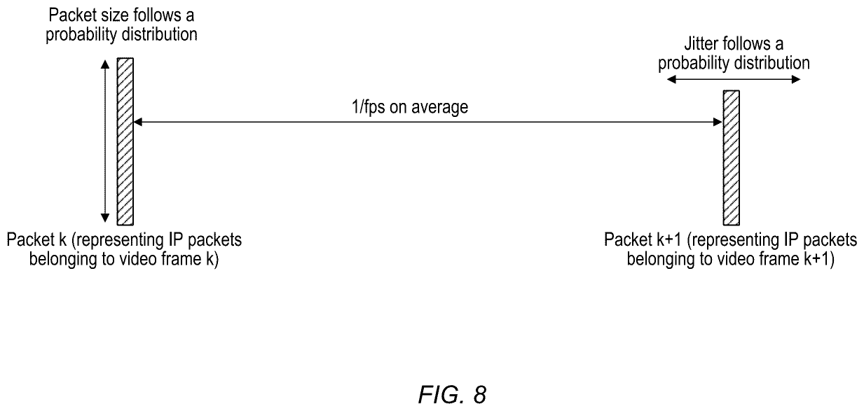

The radio access network (RAN) can obtain assistance information relating to various characteristics of the XR traffic and utilize this assistance information to perform appropriate resource allocations/assignments, e.g., to served UEs, for XR services. Due to the periodical nature of XR(-related) transmissions, configured grants (CGs) are expected to provide a key resource allocation method for UL XR traffic. A CG essentially allocates/assigns preconfigured periodical UL radio resource(s), such as time resources and frequency resources, for example, which enable the UE to anticipate in advance where (in the time-frequency resource grid) the physical uplink shared channel (PUSCH) resources are available for UL, without requiring dynamic signaling to identify those resource allocations. An example preconfigured resource allocation with Periodicity=T, which can be established via a CG, is illustrated in FIG. 7.

### Jitter and Varying-Payload of XR Traffic

According to certain portions of the 3GPP technical reports, the periodic XR traffic may be associated with random jitter, where the actual packet arrival time may be offset from the nominal timing (based on traffic periodicity). The packet size may also vary over time. This is illustrated in FIG. 8, which shows an example diagram depicting respective IP packets belonging to corresponding video frames of a video stream. Configured scheduling, via CGs, for example, can be enhanced to accommodate these traffic characteristics occurring during UL transmissions. The following issues may be considered in view of varying packet sizes in case of a CG with fixed transport block size (TBS):
When the packet size is larger than the TBS of a CG occasion, it cannot be accommodated within one CG cycle. This may increase latency; and
When the packet size is smaller than the TBS of a CG occasion, it is not resource efficient. The base station could have allocated the resource to other UE(s).
   CGs with Multiple PUSCH (Multi-PUSCH) Occasions

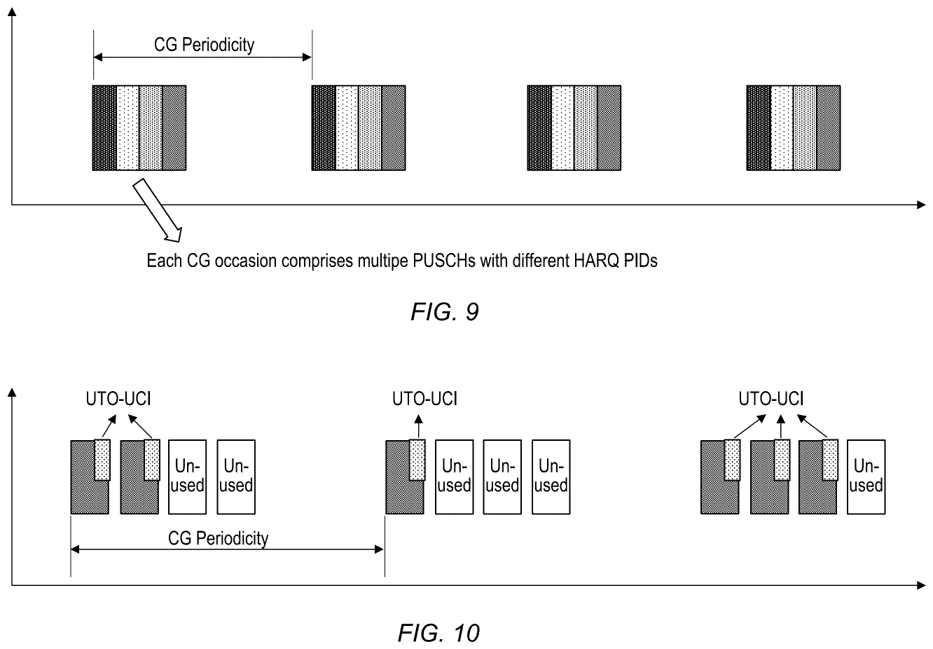

To accommodate periodic traffic with varying packet sizes, the following objectives have been identified:
Multiple CG PUSCH transmission occasions in a period of a single CG PUSCH configuration; and
Dynamic indication of unused CG PUSCH occasion(s) via uplink control information (UCI) by the UE.
   CGs with multi-PUSCH occasions are typically used for traffic with varying packet sizes, such as audio/video, for example. An example of a CG with multiple PUSCH occasions per period is illustrated in FIG. 9.

### Indications for Unused Transmission Occasions

Due to the varying packet size of periodic XR traffic, the UE does not necessarily require use of every single PUSCH occasion within the CG cycle. As currently established, a UE can send an indication to its serving base station (e.g., to its serving gNB) to inform the base station which PUSCH occasions (or which PUSCHs within the CG cycle) are not to be used, and the base station can therefore allocate the resources associated with those unused PUSCHs (or PUSCH occasions) to other UEs. This indication is referred to as “Unused Transmission Occasions UCI” or UTO-UCI, which is a new type of UCI that can be multiplexed into PUSCH (akin to CG-UCI). Per current agreements, the UTO-UCI is expected to be included in every CG PUSCH that is transmitted. In some embodiments, the UTO-UCI can be provided as a bitmap, where a bit corresponds to a PUSCH transmission occasion within a time duration or range, and the bit indicates whether the PUSCH transmission occasion is used or unused. In general, the information to be conveyed by UTO-UCI can be generated/provided to the physical layer (PHY) by the media access control (MAC) layer for signaling, since the data buffer size is visible to the MAC layer/control. FIG. 10 provides an example timing diagram of CG cycles where UTO-UCI is provided to the base station by the UE.

### HARQ Process ID Determination

Determination of the HARQ process IDs (PIDs) for each transmission occasion in a multi-PUSCH CG has not been fully standardized. There are, however, several working assumptions regarding this process.

The HARQ PID for the first configured/valid PUSCH in a period is determined based on a legacy CG procedure when the CG retransmission timer (cg-RetransmissionTimer) is not configured. That is, the HARQ PID for the first PUSCH is determined by a formula expressed as:

$$HARQ Process I D = [ floor ( X * ( CURRENT\_symbol - offset 1 ) / periodicity ) + offset 2 ] modulo nrofHARQ - Processes .$$

The details for the parameters used in this formula are provided in the 3GPP specification TS.38.321. The HARQ process ID of the remaining configured/valid CG PUSCHs in the CG period is determined by incrementing the HARQ process ID of the preceding PUSCH in the CG period by a specific value, Y. In some embodiments, the value of Y may be set to 1.

### Configured Grant Timer

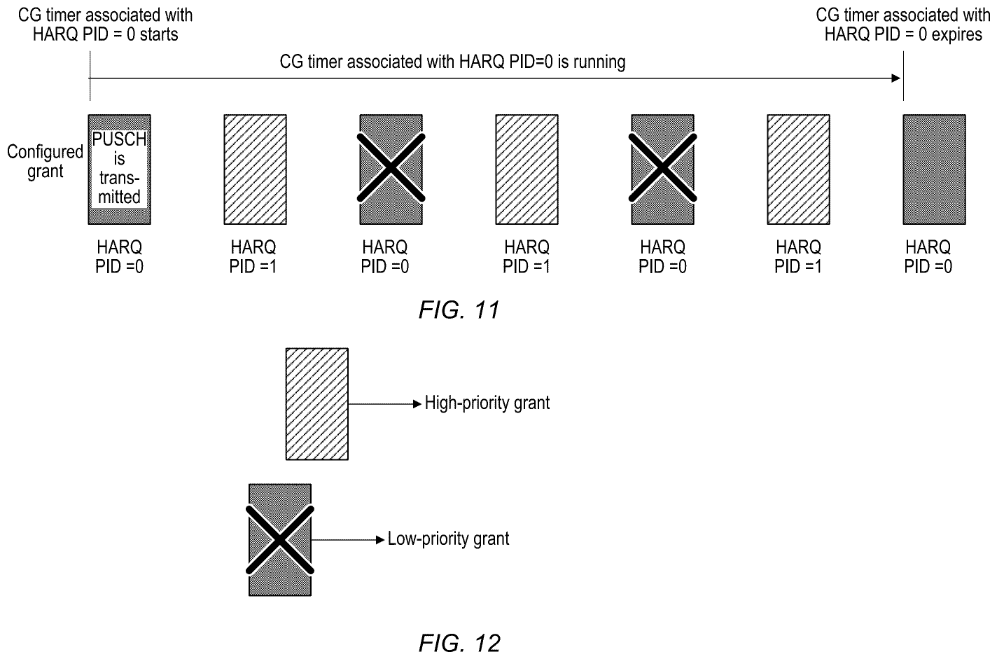

As noted above, currently, each CG PUSCH is associated with a HARQ PID, which can be derived from a specified formula. In case of a CG with multi-PUSCH occasions (as described above), a CG configuration can include multiple CG PUSCHs (or PUSCH occasions) per period with different HARQ PIDs. A CG timer is started when a PUSCH is transmitted (e.g., the CG time is started on the first OFDM symbol of the PUSCH). The CG timer is associated with the HARQ process of the given PUSCH. The PUSCH can be associated with a CG or a dynamic grant (DG). It should be noted that in the present context, the terms PUSCH, PUSCH occasion, PUSCH transmission occasion are used interchangeably in reference to UL communications or opportunities for UL communications that are performed via a given PUSCH, e.g., using radio resources associated with the given PUSCH. Furthermore, more broadly, radio resources can also be collectively associated with a given grant, e.g., with a given CG. In other words, the collective radio resources used by all PUSCH occasions of a CG are said to be associated with or used by the CG. While the CG timer associated with the HARQ PID (or HARQ process having a given PID) is running, the UE may not use CG resources associated with that same HARQ process (or HARQ PID) to avoid overwriting (by a new transmission) the MAC PDU stored in the HARQ buffer, as the stored MAC PDU may still be needed for the HARQ retransmission. FIG. 11 provides an example timing diagram illustrating PUSCH occasions associated with two different HARQ IDs. As indicated in FIG. 11, while the CG timer associated with HARQ PID=0 is running, the PUSCH resources associated with HARQ PID=0 may not be used by the UE.

### Intra-UE Prioritization

In 5G NR, a UE can perform “intra-UE prioritization” functionality. That is, if the UE has multiple UL grants whose PUSCH resources at least partially overlap in time, e.g., UL communications configured by the respective UL grants overlap in time, the UE can select the UL grant with the highest priority. The grant priority can be determined based on the priority of the logical channels (LCHs) that are mapped or will be mapped to a grant. Similarly, intra-UE prioritization can be performed for a UL (data) grant and a physical uplink control channel (PUCCH.) For example, if the PUCCH is used to transmit the scheduling request (SR) triggered by an LCH having higher priority than the data to be carried by the uplink grant, the UE can prioritize the PUCCH, and the PUSCH transmission of the deprioritized grant may not take place. As illustrated in FIG. 12, the transmission occasion associated with a high-priority grant can take precedence over a transmission occasion associated with a low-priority grant, relative to each other, which can lead to the transmission occasion associated with the low-priority, or lower-priority grant not taking place (e.g., because it is not processed.)

### Issues Relating to CG Scheduling and Associated Communications

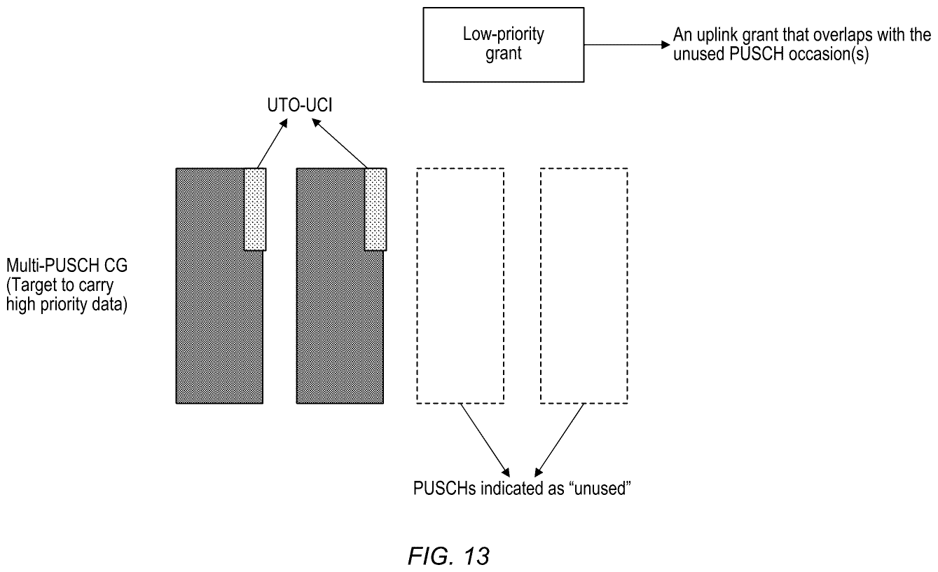

Various issues may be considered regarding the CG scheduling and associated communications discussed above. These issues include:
1. When should the UE determine the HARQ process ID for each transmission occasion of a multi-PUSCH CG cycle;
2. As some of the transmission occasions are not to be used due to a running CG timer, how should the UE (e.g., the via a MAC entity) determine the UTO by taking the CG timer status into account;
3. If intra-UE prioritization (e.g., logical-channel based prioritization, or LCH-based prioritization) is configured, some of the transmission occasions are not to be used when their resources overlap with other grants that can carry data having higher priority. In those cases, how should the UE (e.g., via a MAC entity) determine the UTO by taking intra-UE prioritization into account;
4. How resource efficiency can be improved when there are transmission occasions within a multi-PUSCH CG whose default HARQ processes are blocked by a running CG timer;
5. When the UE (e.g., the MAC entity within the UE) is configured with LCH-based prioritization, even after a given PUSCH has been declared “unused” it can still be associated with a high(er)-priority grant, e.g., if some high-priority data that can be mapped to the given PUSCH has arrived after the UE has transmitted the UTO-UCI. Hence, any uplink grants whose resources overlap in time with the duration of this “unused” PUSCH can become unnecessarily deprioritized. This presents the issue of how to avoid unnecessary deprioritization of uplink grant(s) whose PUSCH(s) overlap(s) with transmission occasions that have already been indicated as “unused.”
   Issue 5 is illustrated in FIG. 13. Per current 3GPP specifications, grant prioritization does not account for grants that have already been determined (or indicated) to be “unused.” Therefore, certain grants may be unnecessarily deprioritized.

### First Proposal: Timing for HARQ Process ID Determination

Two options may be considered for the timing for HARQ PID determination for a multi-PUSCH CG:
First Option: The UE can determine the HARQ PID for each transmission occasion right before processing its corresponding PUSCH; and
Second Option: The UE can determine the HARQ PIDs for all transmission occasions of a multi-PUSCH CG cycle (e.g., at once), prior to processing the first PUSCH of the multi-PUSCH CG cycle.

The first option is more aligned with modelling of the present MAC specification (i.e., 3GPP specification.) However, this may present problems for a UE when deriving/determining UTO(s) for a multi-PUSCH CG. Per current agreements, the UE is expected to send UTO-UCI in every PUSCH, which means the UE is also expected to determine UTO(s) of the given multi-PUSCH cycle prior to the first PUSCH (occasion). Therefore, the UE is expected to first identify which of the PUSCH(s) may be blocked (e.g., blocked from use) by a running CG timer. However, for this to occur, the UE is expected to be aware of (or to identify) the HARQ PID of each PUSCH upfront. If the UE has not identified the respective HARQ PIDs associated with each PUSCH(s) or PUSCH occasion(s) when attempting to identify UTO(s), it may overlook transmission occasions that are blocked by the running CG timer, and may therefore possibly incorrectly identify UTO(s). For example, a scenario can develop in which the UE has already indicated it is going to use a specific PUSCH, but it cannot use that specific PUSCH because the CG timer associated with the HARQ process (or HARQ PID) corresponding to (or associated with) this specific PUSCH is running.

For at least the above reason, at least in some embodiments, the second option is preferable. Accordingly, in some embodiments, for a multi-PUSCH CG (cycle), the UE can determine the corresponding HARQ PIDs for all transmission occasions prior to processing the first PUSCH of the multi-PUSCH CG cycle. For example, the HARQ PIDs can be determined all at once.

### Second Proposal: Method for UTO Determination Based on CG Timer

A procedure can be performed to determine or identify UTO(s). In some embodiments, the procedure can be performed by the MAC in the UE. Information identifying the UTO(s) can be subsequently delivered to the physical layer (PHY) for UTO-UCI signaling by the UE. In some embodiments, the procedure may include:
Step 1: Determining the respective HARQ PIDs for all transmission occasions of a given multi-PUSCH CG cycle, prior to processing the first PUSCH of the given multi-PUSCH CG cycle;
Step 2: Identifying transmission occasions that may be blocked by running CG timers (if any), in accordance with the HARQ PIDs determined in Step 1. The UE can consider these identified transmission occasions as UTOs or as invalid CG PUSCH occasions (or invalid PUSCH transmission occasions), leaving remaining transmission occasions as the usable transmission occasions;
Step 3: Determining how many of the remaining usable transmission occasions are required to accommodate all the data buffered in the LCH/LCG that is allowed to use the resource(s) of (or corresponds to) the given multi-PUSCH CG;
   If all remaining transmission occasions are required to accommodate all the data buffered in the allowed LCH/LCG, then only the transmission occasions identified in Step 2 are considered as UTOs or as invalid PUSCH transmission occasions,
   If only a subset of the remaining transmission occasions is required to accommodate all the data buffered in the allowed (or corresponding) LCH/LCG, then any transmission occasion(s) not included in the subset can also be considered as UTO(s) or invalid PUSCH transmission occasions.
Step 4: Delivering the information identifying UTOs or invalid PUSCH transmission occasions, as identified based on Step 2 and Step 3, to PHY, for UTO-UCI signaling by the UE.

Based at least on the above, in some embodiments, a method for identifying or determining unused transmission occasions of (or associated with) a multi-PUSCH CG (cycle) can be performed, e.g., by a MAC entity. The method can include determining corresponding HARQ PIDs for one or more transmission occasions of a multi-PUSCH CG and determining which of the one or more transmission occasions (or PUSCH transmission occasions) have a corresponding HARQ PID associated with a CG timer that may be running at a time when the transmission occasion is to occur or is to be processed. To put it another way, the status of the CG timer can be evaluated for the multiple transmission occasions according to the corresponding HARQ PIDs of the multiple transmission occasions. The method can further include identifying a set of UTOs (if any) among the transmission occasions of the multi-PUSCH CG, based on the status of the CG timer, and, in some embodiments, further based on status of a buffer. If the CG timer associated with the HARQ PID of a given transmission occasion of a multi-PUSCH CG (cycle) may be running at the time when the transmission occasion is to occur or is to be processed, the given transmission occasion can be identified/indicated as a UTO, regardless of whether the UE intends to use this transmission occasion for transmitting the data from the UE's transmit buffer. In some embodiments, in such a scenario, the given transmission occasion is always identified/indicated as a UTO. The method can further include delivering information that identifies the set of UTOs to the PHY for transmission by the UE in UTO-UCI.

### Third Proposal: Method for UTO Determination Based on Prioritization

Two different scenarios may be considered when determining UTOs based on prioritization. In a first scenario, the UE may have already determined or been instructed that some of the transmission occasions will not occur due to intra-UE prioritization. For example, some high priority data may have already arrived in the buffer and may be awaiting to use a high-priority grant. In a second scenario, the UE may have already determined or been instructed that some of the transmission occasions may be potentially deprioritized, but the de-prioritization is not certain (e.g., high priority data may have not yet arrived in the buffer).

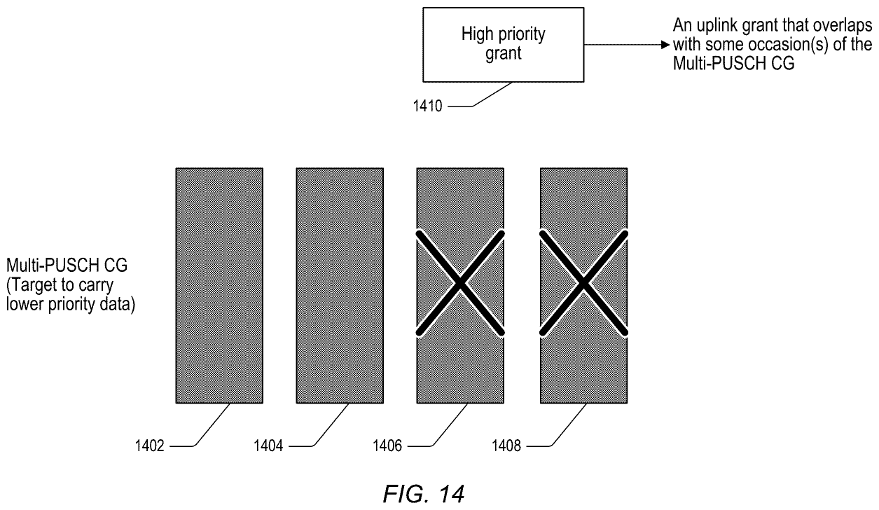

In case of the first scenario, the UE can also determine UTO(s) for the given multi-PUSCH CG by considering whether a transmission occasion is deprioritized relative to another transmission (e.g., a PUSCH or a scheduling-request-PUCCH, SR-PUCCH, having a higher priority). This is illustrated in FIG. 14, which shows an example timing diagram with four transmission occasions (1402, 1404, 1406, 1408) of a multi-PUSCH CG during which the target is carrying lower priority data. As illustrated in FIG. 14, resources of a high-priority UL grant 1410 overlap with transmission occasions 1406 and 1408 of the multi-PUSCH CG. Accordingly, transmission occasions 1406 and 1408 are determined/identified as unused UTOs or as invalid CG PUSCH occasions since they collide with UL grant 1410.

Based at least on the above, in some embodiments, a method for identifying or determining unused transmission occasions of (or associated with) a multi-PUSCH CG (cycle) can be performed, e.g., by a MAC entity, and can include determining that one or more radio resources to be used by a PUSCH transmission occasion of a multi-PUSCH CG overlaps in time with one or more radio resources to be used for a higher priority transmission relative to the PUSCH transmission occasion, evaluating whether the higher priority transmission is to be performed, identifying a set of UTOs or invalid CG PUSCH occasions (if any) among the transmission occasions of the multi-PUSCH CG, based on the evaluation and further based on a buffer status, and delivering, to the PHY, information that identifies the set of UTOs and invalid CG PUSCH occasions. The information can be transmitted by the UE, e.g., in a UTO-UCI to a base station.

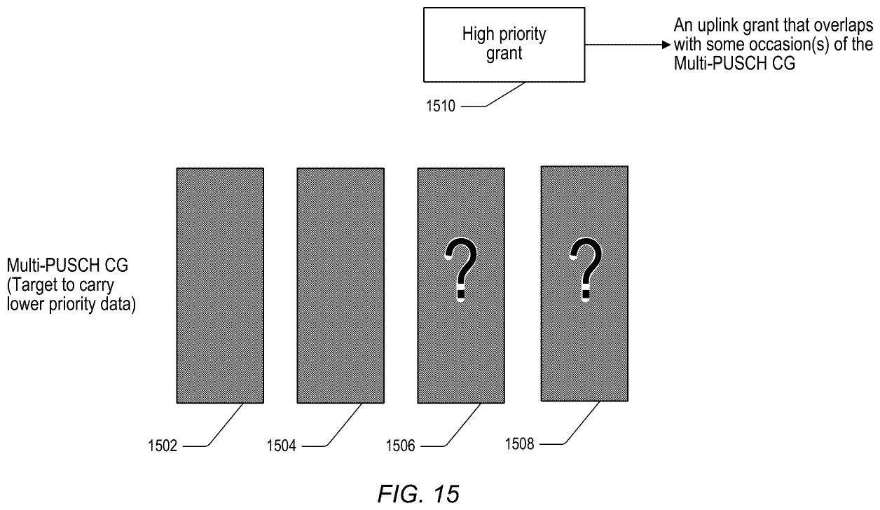

In case of the second scenario, the UE can still indicate (e.g., via UTO-UCI) that given PUSCH transmission occasions of a multi-PUSCH CG are to be used (e.g., they are not identified as UTOs), and two different actions can be taken when high priority data (if any) associated with the same radio resources as the given PUSCH transmission occasions arrives:
The UE may deprioritize the given PUSCH transmission occasions; or
The UE may not deprioritize the given PUSCH transmission occasions since the UE has already indicated that they are to be used.
   In some embodiments, if the given PUSCH transmission occasion is to be deprioritized, the UE can update the UTO by changing the given PUSCH from a “used” transmission occasion to an “unused” transmission occasion and send the UTO-UCI to indicate the update(s). This is illustrated in FIG. 15, which shows an example timing diagram with four transmission occasions (1502, 1504, 1506, 1508) of a multi PUSCH CG during which the target is carrying lower priority data. As illustrated in FIG. 15, resources of a high-priority UL grant 1510 overlap with transmission occasions 1506 and 1508 of the multi-PUSCH CG. The transmission occasions 1506 and 1508 may or may not be deprioritized, and therefore may or may not be considered UTOs (or invalid CG PUSCH occasions.) For example, the UE can determine whether or not to deprioritize transmission occasions 1506 and 1508, and can either deprioritize or not deprioritize transmission occasions 1506 and 1508 based on the determination.

### Fourth Proposal: Re-Mapping of HARQ PID

By default, the HARQ PIDs for a multi-PUSCH CG can be derived based on the following rules:
The HARQ PID for the first configured/valid PUSCH in a period can be determined based on a legacy CG procedure when a CG (retransmission) timer is not configured. For example, the HARQ PID for the first PUSCH can be determined by a formula:

HARQ Process ID=[floor(X*(CURRENT_symbol−offset1)/periodicity)+offset2]modulo nrofHARQ-Processes
The HARQ PID of any remaining configured/valid CG PUSCHs which do not yet correspond to a HARQ PID in the CG period can be determined by incrementing the HARQ PID of the preceding PUSCH in the CG period by a specified number, Y. In some embodiments, the value of Y may be 1. For example, for a multi-PUSCH CG cycle with four (4) PUSCH transmission occasions, if the HARQ PID of the first PUSCH transmission occasion is determined to be 3, the HARQ PIDs of the remaining PUSCHs may be defined as 4, 5, and 6 respectively (incremented by 1 from the HARQ PID of the preceding PUSCH transmission occasion).

According to the First Proposal discussed above, the UE can identify some of the transmission occasions within the multi-PUSCH CG that cannot be used due to the running CG timer. According to the Fourth Proposal, the UE can operate to change the rule/method used for deriving the HARQ PID of (or associated with) at least one PUSCH if one or more of the transmission occasions in a multi-PUSCH CG cannot be used due to the running CG timer, such that the UE is enabled to nevertheless use these resources in order to improve efficiency.

Accordingly, the UE can perform the following method:
Step 1: The UE determines HARQ PIDs for one or more PUSCH transmission occasions in a multi-PUSCH CG cycle, based on a default method or rule (e.g., according to the First Proposal disclosed above);
Step 2: The UE determines if one or more of the determined HARQ PIDs cannot be used due to a running CG timer (e.g., a running CG timer is associated with the one or more determined HARQ PIDs) for PUSCH transmission occasions of the multi-PUSCH CG cycle that the UE intends to use. If it is determined that one or more of the determined HARQ PIDs cannot be used, the UE can switch or change or remap the HARQ PID for at least one of the PUSCH transmission occasions in the multi-PUSCH CG cycle, based on an alternative method or rule (which may differ from the default method/rule used to initially determined the HARQ PIDs). For example, if the HARQ PID determined based on the default method, e.g., Y=1, cannot be used, the UE can change the previously determined HARQ PID by using an alternative method, e.g., changing the value of Y, such as setting Y=2. The UE can continue changing the value of Y until the HARQ PID is determined to be usable. If it is determined that there are no unusable HARQ PIDs, the UE proceeds to Step 3.
Step 3: The UE determines the information that identifies UTOs based on data buffer status and further based on the HARQ PIDs determined in Step 1 or Step 2 (e.g., the UE can thereby determine information that identifies UTOs based on the Second Proposal disclosed above). It should be noted that the UE may not switch or change or remap HARQ PID(s) (as described above in Step 2) associated with PUSCH transmission occasions of the multi-PUSCH CG cycle that the UE does not intend to use/process. For example, the UE may have already indicated (or decided to indicate) this PUSCH as a UTO.

In some embodiments, the UE may repeat Step 2 for up to N>=1 times, the proceed to Step 3 when N is reached regardless of the derived HARQ PID results. In some embodiments, the UE may repeat Step 2 until none of the determined HARQ PIDs are blocked by a running CG timer, or until no determined HARQ PIDs associated with PUSCH transmission occasions that are to be used are blocked by the running CG timer. In some embodiments, the difference between the default method/rule and the alternative method/rule can be e.g., the value of Y (as disclosed above). In some embodiments, when applying the alternative method/rule to change or remap or switch a HARQ PID previously determined via the default method/rule, the UE can directly select an alternative HARQ PID that is nearest/closest (either higher or lower) to the previously determined HARQ PID and is not blocked by a running CG timer. In some embodiments, the UE can indicate to a serving base station of the UE (e.g., to a serving gNB) which method/rule the UE has used, e.g., the UE can indicate the value of Y. The UE can also indicate the finalized HARQ PID results for one or more multi-PUSCH CGs to the serving base station. In some embodiments, the UE can apply such behaviors to specific CG configurations.

Fifth Proposal: Grant Prioritization with UTO Consideration

Presently, when LCH-based prioritization is configured, the priority of an UL grant is determined by the highest priority among priorities of the logical channels (LCHs) that are multiplexed in the MAC PDU (e.g., the MAC PDU to be transmitted is already stored in the HARQ buffer) or have available data that can be multiplexed in the MAC PDU (e.g., the MAC PDU to be transmitted is not yet stored in the HARQ buffer), according to the mapping restrictions. The priority of an UL grant for which no data for logical channels is multiplexed in the MAC PDU or can be multiplexed in the MAC PDU is lower than either the priority of an UL grant for which data for any logical channel is multiplexed in the MAC PDU or can be multiplexed in the MAC PDU, or the priority of the logical channel triggering an SR.

Accordingly, a transmission occasion that has been indicated as “unused” can still be considered high-priority if data that can be multiplexed into the buffer arrives to the buffer after the UTO-UCI has already been transmitted. That is, the priority of the grant can still take LCH priority into account due to such data availability, even though the UE is not planning on using this transmission occasion as part of the multi-PUSCH CG since it has already been identified as a UTO. It is worth noting that the UE may not be allowed to use a PUSCH that has already been indicated as a UTO, even if the UE has data available in the buffer that can be transmitted on such a PUSCH. The UL grants whose resources overlap with this UTO may not be considered as “prioritized UL grants” according to current specifications, because the status of being a UTO is not considered by the prioritization rule. It should also be noted that due to considerations such as described above, transmission occasions that may have at one point been identified as UTOs (or, radio resources associated with those UTOs) can still be used for transmission or reevaluated as not effectively becoming UTOs.

The above considerations are expressed by the following example segment from the current 3GPP specifications (TS 38.321), with the most relevant sections in bold:
1> if this uplink grant is received in a Random Access Response (i.e., in a MAC RAR or fallback RAR), or addressed to Temporary C-RNTI, or is determined as specified in clause 5.1.2a for the transmission of the MSGA payload:
   2> consider this uplink grant as a prioritized uplink grant.
   1> else if this uplink grant is addressed to CS-RNTI with NDI=1 or C-RNTI:
      2> if there is no overlapping PUSCH duration of a configured uplink grant which was not already deprioritized and the simultaneous transmission of the SR and the uplink grant is not allowed by configuration of simultaneousPUCCH-PUSCH, in the same BWP whose priority is higher than the priority of the uplink grant; and
      2> if there is no overlapping PUCCH resource with an SR transmission which was not already de-prioritized and the priority of the logical channel that triggered the SR is higher than the priority of the uplink grant:
      3> consider this uplink grant as a prioritized uplink grant;
   3> consider the other overlapping uplink grant(s), if any, as a de-prioritized uplink grant(s);
3> consider the other overlapping SR transmission(s), if any, as a de-prioritized SR transmission(s).

In order to address the issue described above, the MAC specification can be updated such that the UE is enabled to consider whether the overlapping PUSCH is a transmission occasion that has already been declared as “unused,” (e.g., it has been identified as or determined to be a UTO) when determining whether an UL grant should be considered as a prioritized UL grant. For example, the fourth section (second 2>section) of the portion of the specification provided above be modified as follows, with the modification in bold:
2> if there is no overlapping PUSCH duration of a configured uplink grant which was not already deprioritized and has not been indicated as an unused transmission occasion and the simultaneous transmission of the SR and the uplink grant is not allowed by configuration of simultaneousPUCCH-PUSCH, in the same BWP whose priority is higher than the priority of the uplink grant; and
   Alternatively, a rule can be defined in the MAC specification such that a transmission occasion determined to be a UTO is directly or automatically considered to be a deprioritized UL grant. Accordingly, radio resource(s) overlapping with the UTO can be excluded from consideration when determining the priority of an UL grant.

Based at least on the above, in some embodiments, a method for identifying or determining a prioritized grant can be performed, e.g., by a MAC entity, and can include evaluating whether the PUSCH duration of a first grant overlaps with the PUSCH duration of a second grant, determining whether the PUSCH duration of the second grant corresponds to a transmission occasion already identified as a UTO, and determining whether the first grant is considered a prioritized grant at least partially based on the determination of whether the PUSCH duration of the second grant corresponds to a transmission occasion previously identified as a UTO.

### Sixth Proposal: Event-Triggered UTO Update

Per current agreements, the UE may update the UTO information (more generally, the designation of a transmission occasion as used or unused) with the following restrictions:
A CG PUSCH occasion previously indicated as “unused” may not be later indicated as “NOT unused” (or “used”);
A CG PUSCH occasion previously indicated as “NOT unused” (or “used”) may be later indicated as “unused.”
   In other words, the designation of a CG PUSCH occasion, or transmission occasion, may be changed to “unused” if the CG PUSCH occasion, or transmission occasion, was previously designated as “used,” but not the other way around.

One issue is at which point the designation of a transmission occasion may be reevaluated. In some embodiments, determination of the used/unused status of a transmission occasion can be performed by a MAC entity. In some embodiments, the UE can reevaluate and/or update (if required) the UTO designation when certain conditions are met and/or certain events have occurred. For example, in some embodiments, reevaluation of the UTO designation can be triggered when at least one of the following conditions are met:
Part of the data buffered in at least one logical channel (LCH) is discarded;
All data buffered in at least one LCH is discarded;
The amount (or size) of discarded data in at least one LCH satisfies a threshold value;
The amount (or size) of remaining data in at least one LCH, after discarding data from the LCH, satisfies a threshold value;
Part of the data buffered in at least one LCH is multiplexed into another transmission resource;
All data buffered in at least one LCH is multiplexed into another transmission resource;
The amount (or size) of data in at least one LCH multiplexed into another transmission resource satisfies a threshold value;
The amount (or size) of remaining data in at least one LCH, after part of the data in the LCH has been multiplexed into another transmission resource, satisfies a threshold value;
The remaining time until expiration of a discard timer (or until expiration of the delivery deadline) for data in at least one LCH satisfies a threshold value;
It has been determined that some of the resources may not be used as a result of:
   The CG timer associated with the HARQ process of (or associated with) a CG PUSCH (occasion) may be running when the CG PUSCH occasion is to occur or is to be processed;
   A CG PUSCH (occasion) being potentially deprioritized by another transmission (e.g., PUSCH or PUCCH) partially overlapping in time with the CG PUSCH (occasion).

For the conditions described above, the “at least one logical channel (LCH)” can be an LCH associated with the targeted multi-PUSCH CG (occasion). That is, the LCH can be mapped (or is considered mappable) to the resource(s) of this CG configuration according to previously configured LCH mapping restrictions.

In some embodiments, when the reevaluation/update of UTO designation of one or more CG PUSCH occasions, or transmission occasions, are to be performed, the UE can revaluate/update the UTO designation based on the status of the CG timers associated with the HARQ PIDs of the corresponding transmission occasions. For example, if the CG timer associated with the HARQ PID of a transmission occasion may be running at the time when the transmission occasion is to occur or is to be processed, the transmission occasion can be updated to be a UTO. In some embodiments, the UE can reevaluate/update the UTO designation based on whether the transmission occasion can be deprioritized by a higher priority transmission (e.g., another PUSCH or PUCCH).

After the UTO designation has been updated/evaluated, the information that identifies the reevaluated/updated set of UTOs can be delivered to the PHY for transmission by the UE in a UTO-UCI.

### Seventh Proposal: CG Timer-Aware Base Station Operations

In some scenarios, a base station (e.g., a gNB) can track the status of a CG timer associated with each HARQ process, and a UE (e.g., a UE in communication with the base station) can determine the UTO-UCI without considering the status of the corresponding CG timer (e.g., the Second Proposal described above is not yet implemented.) However, for a transmission occasion indicated as “used” (or “NOT unused”), if the base station has determined or has been instructed that the transmission occasion is not to be used by the UE due to a corresponding running CG timer, the base station can omit decoding the transmission occasion at all. That is, the base station can operate not to decode such a transmission occasion.

Based at least on the above, in some embodiments, a base station can determine whether to decode a given transmission occasion as follows:
Step 1: The base station receives a UTO-UCI, which indicates that a given transmission occasion will be used by the UE;
Step 2: The base station determines whether the CG timer associated with the HARQ process (or HARQ PID) associated with the given transmission occasion is expected to be running when the given transmission occasion is to be used or is expected to occur:
   If the CG timer is not expected to be running when the given transmission occasion is to be used or is expected to occur, the base station can decode the transmission occasion and may not reallocate the radio resource(s) corresponding to the given transmission occasion to other UEs;
   If the CG timer is expected to be running when the given transmission occasion is to be used or is expected to occur, the base station may not decode the transmission occasion (even if it was indicated as “used” or “NOT unused” by the UE), and may reallocate the radio resource(s) corresponding to the given transmission occasion to other UE(s) if applicable, e.g., if the resources may be needed by the other UE(s).

The above procedure enables the base station to minimize the complexity and/or maximize the efficiency of uplink decoding, while overall system capacity can be improved by enabling the base station to reallocate the corresponding resource(s) if needed.

### Approaches for Multi-PUSCH Configured Grants

Various proposals for characterizing and identifying transmission occasions of a multi-PUSCH CG (cycle) have been described in detail. It should be noted that two overall approaches can be considered for identifying UTOs among all transmission occasions of a multi-PUSCH CG cycle. According to a first overall approach, a UE can first determine the HARQ PIDs for one or more transmission occasions of a multi-PUSCH CG, then identify the UTOs, as applicable. According to a second overall approach, the UE can first identify the UTOs of a multi-PUSCH CG, as applicable, then determine the HARQ PIDs for one or more of the transmission occasions of the multi-PUSCH CG (cycle.)

The First Proposal described above can be considered for the first overall approach. The Fourth Proposal described above can be considered for both the first overall approach and the second overall approach. When applying the Fourth Proposal in the second overall approach, the UE can determine whether it should change or switch or remap the previously determined HARQ PID based on whether the PUSCH is indicated as used or unused in the UTO-UCI.

### Example Wireless Communication Methods

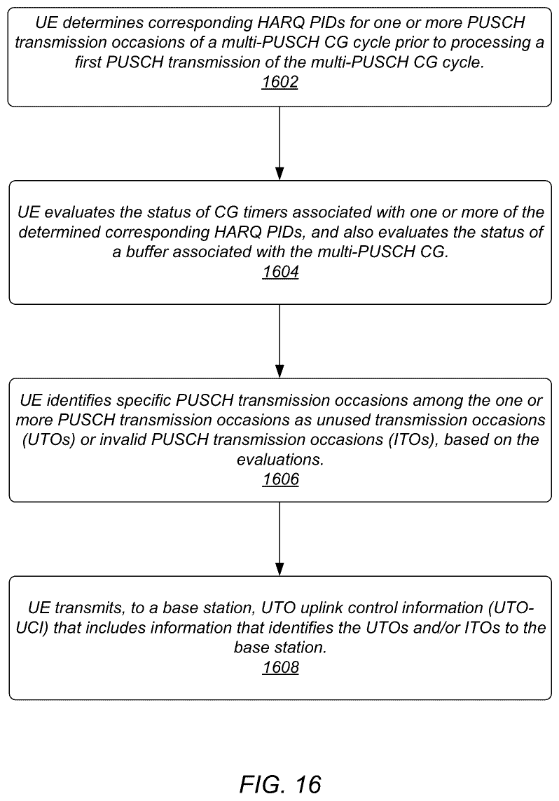

### FIG. 16

FIG. 16 shows an example flow diagram for wireless communications during which the transmission status of PUSCH transmission occasions of a multi-PUSCH CG cycle is determined based at least on a CG timer, according to some embodiments. As shown in FIG. 16, a UE can determine corresponding HARQ PIDs for one or more PUSCH transmission occasions of a multi-PUSCH CG cycle prior to processing a first PUSCH transmission of the multi-PUSCH CG cycle (1602). In some embodiments, the UE can determine the corresponding HARQ PIDs for all PUSCH transmission occasions of the multi-PUSCH CG cycle prior to processing the first PUSCH transmission of the multi-PUSCH CG cycle. The UE can evaluate the status of CG timers associated with one or more of the determined corresponding HARQ PIDs and can also evaluate the status of a buffer associated with the multi-PUSCH CG (1604). The UE can identify specific PUSCH transmission occasions among the one or more PUSCH transmission occasions as unused transmission occasions (UTOs) or invalid PUSCH transmission occasions (ITOs), based at least on the evaluations performed in 1604 (1606). The UE can transmit, to a base station, UTO uplink control information (UTO-UCI) that includes information that identifies the UTOs and/or ITOs to the base station (1608). In addition, the UE can also subsequently perform UL communications without using the UTOs and ITOs.

In some embodiments, evaluating the status of the CG timers can include determining that the specific PUSCH transmission occasions may be blocked by the CG timers running for the determined HARQ PIDs that correspond to the specific PUSCH transmission occasions. In some embodiments, evaluating the status of the buffer can include determining that a subset of remaining PUSCH transmission occasions of the multiple PUSCH transmission occasions not identified as UTOs or ITOs is required to accommodate data buffered in one or more logical channels (LCHs) allowed to use resource(s) of the subset of PUSCH transmission occasions, and identifying PUSCH transmission occasions of the remaining PUSCH transmission occasions not included in the subset as UTOs or ITOs.

In some embodiments, the above-described procedures can be performed by a media access control (MAC) entity in the UE. The MAC entity can provide, to a physical layer (PHY) in the UE, the information that identifies the UTOs and/or ITOs, so that the UE may transmit the UTO-UCI to a base station.

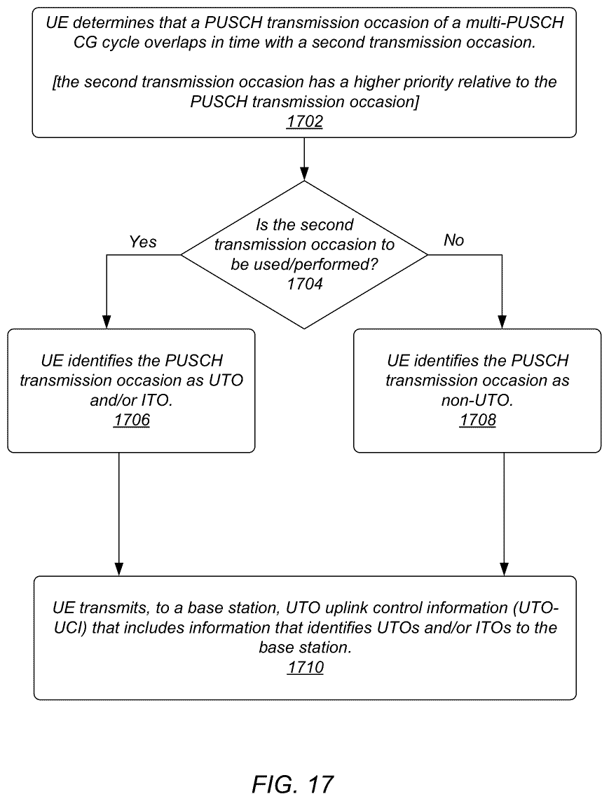

### FIG. 17

FIG. 17 shows an example flow diagram for wireless communications during which the transmission status of PUSCH transmission occasions of a multi-PUSCH CG cycle is determined based at least on grant prioritization, according to some embodiments. As shown in FIG. 17, a UE can determine that a PUSCH transmission occasion of a multi-PUSCH CG cycle overlaps in time with a second transmission occasion, where the second transmission occasion has a higher priority relative to the PUSCH transmission occasion (1702). The UE can then identify the PUSCH transmission occasion as UTO and/or ITO, based at least in response to determining that the second transmission occasion is to be used/performed (‘Yes’ from 1704). The UE can subsequently transmit, to a base station, UTO-UCI identifying the UTO and/or ITOs (1710). The UE can use a MAC entity to perform these procedures, and the MAC entity can deliver, to the PHY of the UE, information that identifies the UTO and/or ITO. The UTO-UCI can then be determined based at least on the information provided to the PHY.

Determining that the second transmission occasion is to be performed can include determining that data to be transmitted via the second transmission occasion is present in a transmit buffer. The second transmission occasion can be a second PUSCH transmission occasion that is not part of the multi PUSCH CG cycle, or it can be a physical-uplink-control-channel (PUCCH) transmission occasion.

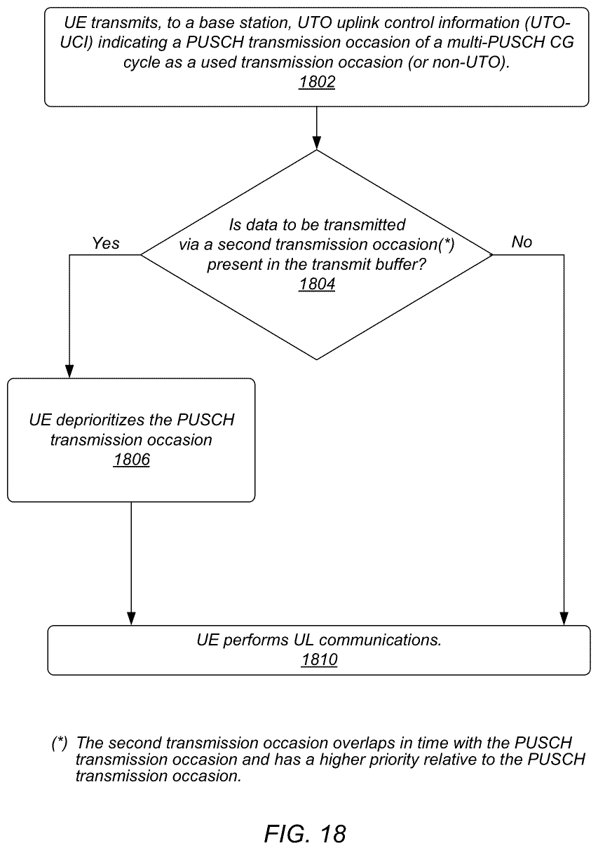

### FIG. 18

FIG. 18 shows an example flow diagram for wireless communications during which the transmission status of PUSCH transmission occasions of a multi-PUSCH CG cycle is determined based at least on grant prioritization, and a PUSCH transmission occasion of the multi-PUSCH CG cycle is deprioritized, according to some embodiments. As shown in FIG. 18, the UE can transmit, to a base station, UTO-UCI indicating a PUSCH transmission occasion of a multi-PUSCH CG cycle as a used transmission occasion or as a non-UTO (1802), The UE can determine that data to be transmitted via a second transmission occasion is present in a transmit buffer, where the second transmission occasion overlaps in time with the PUSCH transmission occasion and has a higher priority relative to the PUSCH transmission occasion (‘Yes’ from 1804). The UE can accordingly deprioritize the PUSCH transmission occasion in response to determining that the data is present in the transmit buffer (1806), and can perform UL communications accordingly (1810).

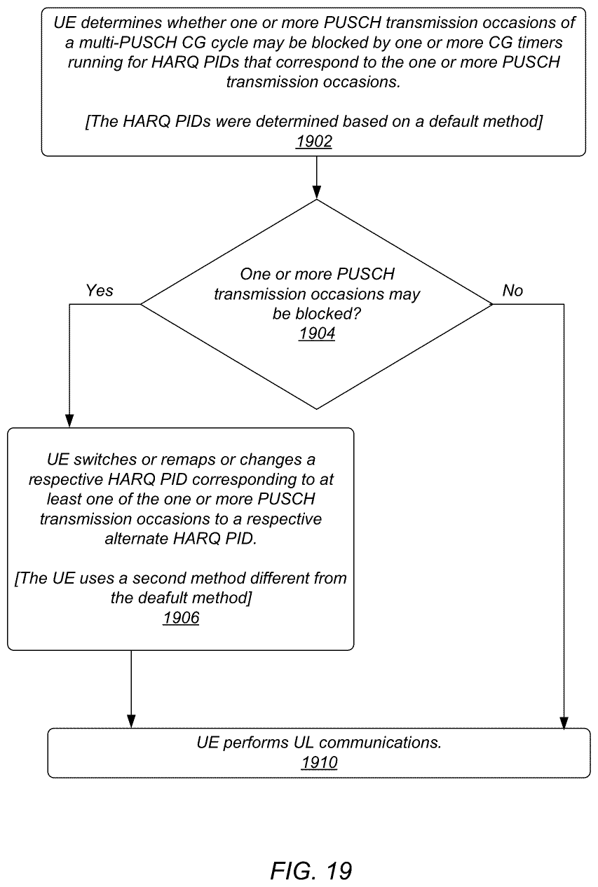

### FIG. 19

FIG. 19 shows an example flow diagram for wireless communications during which at least one HARQ PID associated with a PUSCH transmission occasion of a multi-PUSCH CG cycle is modified. According to some embodiments, the modification may include switching, remapping, and/or changing, among others. As shown in FIG. 19, a UE can determine whether one or more PUSCH transmission occasions of a multi-PUSCH CG cycle may be blocked by one or more CG timers running for HARQ PIDs that correspond to the one or more PUSCH transmission occasions, where the HARQ PIDs were determined based on a default method (1902). The UE can switch or remap or change a respective HARQ PID corresponding to at least one of the one or more PUSCH transmission occasions to a respective alternate HARQ PID (1906), in response to determining that the one or more PUSCH transmission occasions may be blocked by the one or more CG timers (‘Yes’ from 1904). The UE can perform UL communications based at least on the changed respective HARQ PID (1910).

In some embodiments, the UE can determine whether a HARQ PID corresponding to a given PUSCH transmission occasion is to be changed to a respective alternate HARQ PID based at least on whether the given PUSCH transmission occasion is already indicated to be an unused transmission occasion (UTO) and/or an invalid PUSCH transmission occasion (ITO). In some embodiments, the UE can repeat 1902 a specified number, N>=1, times. Alternatively, the UE can continue performing 1902 and 1906 until none of the determined corresponding HARQ PIDs associated with PUSCH transmission occasions of the one or more PUSCH transmission occasions identified as UTOs and/or ITOs are blocked by a running CG timer(s).

In some embodiments, performing 1906 can include using a second method different from the default method. In some embodiments, the default method can include assigning a value to a first HARQ PID and obtaining each following HARQ PID by incrementing, by a specified value Y, an immediately preceding HARQ PID, until all of the corresponding HARQ PIDs have been determined. The second method can include obtaining the respective alternate HARQ PID by incrementing, by a specified value Y′ different from the specified value Y, an immediately preceding HARQ PID. The UE can indicate, to a base station, the specified value Y′.

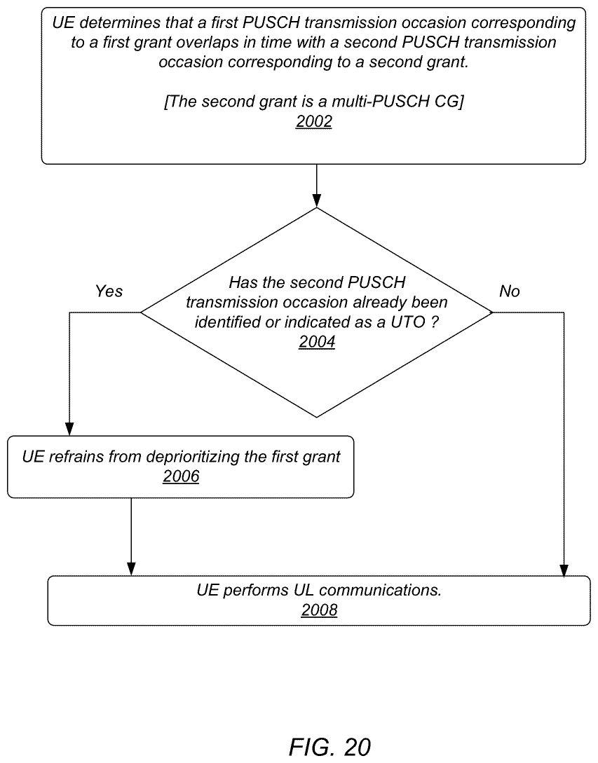

### FIG. 20

FIG. 20 shows an example flow diagram for wireless communications during which uplink grants are prioritized by considering the transmission status of PUSCH transmission occasions of a multi-PUSCH CG cycle, according to some embodiments. As shown in FIG. 20, a UE can determine that a first PUSCH transmission occasion corresponding to a first grant overlaps in time with a second PUSCH transmission occasion corresponding to a second grant (2002), and can further determine whether the second PUSCH transmission occasion has already been identified or indicated as a UTO (2004). The UE may not deprioritize the first grant (2006) in response to determining that the second PUSCH transmission occasion has already been identified or indicated as a UTO (‘Yes’ from 2004). The second grant can be a multi-PUSCH CG. The UE can then perform UL communications accordingly (2008).

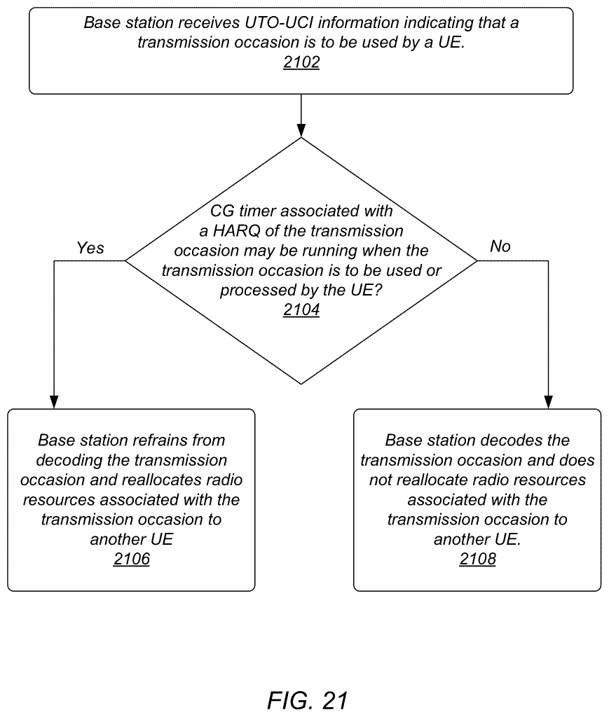

### FIG. 21

FIG. 21 shows an example flow diagram for wireless communications during which a base station can decode or not decode PUSCH transmission occasions of a multi-PUSCH CG cycle based at least on the status of one or more CG timers associated with the PUSCH transmission occasions, according to some embodiments. As shown in FIG. 21, a base station may receive UTO-UCI carrying information indicating that a transmission occasion is to be used by a UE (2102). For example, the UTO-UCI may indicate that the transmission occasion is a non-UTO. The base station can determine whether a CG timer associated with a HARQ (or HARQ PID) of the transmission occasion may be running when the transmission occasion is to be used or processed (2104), and can decode the transmission occasion and not reallocate radio resources associated with the transmission occasion to another UE (2108) at least in response to determining that the CG timer may not be running (‘No’ from 2104), or not decode the transmission occasion and reallocate radio resources associated with the transmission occasion to another UE (2106) at least in response to determining that the CG timer may be running (‘Yes’ from 2104).

### Various Embodiments

Wireless communications performed according to some embodiments disclosed herein can include determining that a first physical uplink shared channel (PUSCH) transmission occasion corresponding to a first grant overlaps in time with a second PUSCH transmission occasion corresponding to a second grant, determining whether the second PUSCH transmission occasion has already been identified or indicated as an unused transmission occasion (UTO), and refraining from deprioritizing the first grant in response to determining that the second PUSCH transmission occasion has already been identified or indicated as a UTO. The second grant can be a multi-PUSCH configured grant (CG).

Wireless communications performed according to some other embodiments disclosed here can include reevaluating a use status of a physical uplink shared channel (PUSCH) transmission occasion of a multi-PUSCH configured grant (CG) cycle in response to one or more of
a portion of data buffered in at least one logical channel (e.g., a specified LCH) being discarded,
all data buffered in the specified LCH being discarded,
an amount of discarded data in the specified LCH satisfying a threshold value,
an amount of remaining data in the specified LCH, after discarding data from the at least one LCH, satisfying a threshold value,
a portion of data buffered in the specified LCH being multiplexed into another transmission resource,
all data buffered in the specified LCH being multiplexed into another transmission resource,
an amount of data in the specified LCH multiplexed into another transmission resource satisfying a threshold value,
an amount of remaining data in the specified LCH, after a portion of the data in the specified LCH has been multiplexed into another transmission resource, satisfying a threshold value,
a remaining time until expiration of a discard timer or expiration of a delivery deadline for data in the specified LCH satisfying a threshold value, and
a determination that some radio resources may not be used as a result of
   a CG timer associated with a hybrid automatic repeat request (HARQ) process of a CG PUSCH occasion may be running when the CG PUSCH occasion is to occur or is to be processed, and
   a CG PUSCH being deprioritized based on another transmission partially overlapping in time with the CG PUSCH.
      Uplink (UL) communications can then be performed according to the reevaluated use status of the PUSCH transmission occasion. Furthermore, reevaluating the use status of the PUSCH transmission occasion can include changing the use status from “used” to “unused”. In some embodiments, the specified LCH can be restricted to be mapped to radio resources of a CG configuration of the multi-PUSCH CG.

Wireless communications performed according to at least some embodiments disclosed herein can include receiving an unused-transmission-occasion-uplink-control-information (UTO-UCI) carrying information indicating that a transmission occasion is to be used by a user equipment (UE), determining whether a configured grant (CG) timer associated with a hybrid automatic repeat request (HARQ) of the transmission occasion may be running when the transmission occasion is used. The transmission occasion can then be decoded in response to determining that the CG timer will not be running. If it is determined that the CG timer may be running, instead of decoding the transmission occasion the radio resources associated with the transmission occasion can be reallocated to another UE.

Wireless communications performed according to at least some embodiments disclosed herein can include transmitting, to a base station, of UTO uplink control information (UTO-UCI) identifying a physical uplink shared channel (PUSCH) transmission occasion of a multi-PUSCH configured grant (CG) cycle as a used transmission occasion. The wireless communications can further include determining that data to be transmitted via a second transmission occasion is present in a transmit buffer, where the second transmission occasion overlaps in time with the PUSCH transmission occasion and has a higher priority relative to the PUSCH transmission occasion, and deprioritizing the PUSCH transmission occasion in response to determining that the data is present in the transmit buffer.

An apparatus, or specifically a baseband processor can be used to perform wireless communications according to at least some embodiments described above and/or can be operated to make possible wireless communications according to at least some embodiments described above, whether disposed in a UE or in a base station. In some embodiments, a UE can include radio circuitry that enables wireless communications of the UE. The UE can also include an apparatus, or specifically a baseband processor coupled with the radio circuitry and interoperating with the radio circuitry to perform wireless communications according to at least some of the various embodiments described above. Similarly, a base station can include radio circuitry that enables wireless communications of the base station, and the base station can. also include an apparatus, or specifically a baseband processor coupled with the radio circuitry and interoperating with the radio circuitry to perform wireless communications according to at least some of the various embodiments described above.

It is well understood that the use of personally identifiable information should follow privacy policies and practices that are generally recognized as meeting or exceeding industry or governmental requirements for maintaining the privacy of users. Personally identifiable information data should be managed and handled so as to minimize risks of unintentional or unauthorized access or use, and the nature of authorized use should be clearly indicated to users.

Embodiments of the present disclosure can be realized in any of various forms. For example, in some embodiments, the embodiments can be realized as a computer-implemented method, a computer-readable memory medium, or a computer system. In other embodiments, the embodiments can be realized using one or more custom-designed hardware devices such as ASICs. Other embodiments can be realized using one or more programmable hardware elements such as FPGAs.

In some embodiments, a non-transitory computer-readable memory medium (e.g., a non-transitory memory element) can be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) can be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A method for wireless communications, the method comprising:
determining corresponding hybrid automatic repeat request process identifiers (HARQ PIDs) for a plurality of physical uplink shared channel (PUSCH) transmission occasions of a multi-PUSCH configured grant (CG) cycle prior to processing a first PUSCH transmission of the multi-PUSCH CG cycle; and
performing uplink (UL) communications based at least on the determined one or more HARQ PIDs.

2. The method of claim 1, further comprising:
evaluating status of CG timers associated with one or more of the determined corresponding HARQ PIDs;
identifying one or more PUSCH transmission occasions among the plurality of PUSCH transmission occasions as unused transmission occasions (UTOs) or invalid PUSCH transmission occasions (ITOs), based at least on the status of the CG timer; and
performing the UL communications without using the UTOs and ITOs.

3. The method of claim 2, wherein identifying the one or more PUSCH transmission occasions among the plurality of PUSCH transmission occasions as UTOs or ITOs, based on the status of the CG timers, comprises:
determining that the one or more PUSCH transmission occasions can be blocked by the CG timers running for the determined HARQ PIDs that correspond to the one or more PUSCH transmission occasions.

4. The method of claim 2, further comprising:
identifying the UTOs and ITOs further based on a buffer status.

5. The method of claim 4, wherein identifying the UTOs and ITOs further based on the buffer status comprises:
determining that a subset of remaining PUSCH transmission occasions of the plurality of PUSCH transmission occasions not identified as UTOs or ITOs is required to accommodate data buffered in one or more logical channels allowed to use resource(s) of the subset of PUSCH transmission occasions;
identifying PUSCH transmission occasions of the remaining PUSCH transmission occasions not included in the subset as UTOs or ITOs.

6. The method of claim 2, further comprising:
transmitting, to a base station, UTO uplink control information (UTO-UCI) comprising information that identifies the UTOs or ITOs or both.

7. The method of claim 2, wherein the evaluating and the identifying are performed by a media access control (MAC) entity in a user equipment device (UE).

8. The method of claim 7, further comprising:
transmitting, by the MAC entity to a physical layer (PHY) in the UE, information that identifies the UTOs, the ITOs, or both.

9. A baseband processor comprising:
memory to store information; and
processing circuitry coupled with the memory and configured to:
determine that a physical uplink shared channel (PUSCH) transmission occasion of a multi-PUSCH configured grant (CG) cycle overlaps in time with a second transmission occasion, wherein the second transmission occasion has a higher priority relative to the PUSCH transmission occasion,
identify the PUSCH transmission occasion as an unused transmission occasion (UTO) or an invalid PUSCH transmission occasion (ITO), based at least in response to determining that the second transmission occasion is to be performed, and
prepare, for transmission to a base station, UTO uplink control information (UTO-UCI) indicating the identified UTO or identified ITO.

10. The baseband processor of claim 9, wherein the processing circuitry is configured to perform the determining and identifying via a media access control (MAC) entity in a user equipment (UE).

11. The baseband processor of claim 10, wherein the processing circuitry is further configured to:
deliver, via the MAC entity to a physical layer (PHY) of the UE, information that identifies the UTO or ITO; and
determine the UTO-UCI based at least on the information.

12. The baseband processor of claim 9, wherein the processing circuitry is configured to determine that the second transmission occasion is to be performed by determining that data to be transmitted via the second transmission occasion is present in a transmit buffer.

13. The baseband processor of claim 9, wherein the second transmission occasion is one of:
a second PUSCH transmission occasion that is not part of the multi-PUSCH CG cycle; or
a physical-uplink-control-channel (PUCCH) transmission occasion.

14. A non-transitory memory element storing instructions executable by processing circuitry to perform operations comprising:
determining whether one or more physical uplink shared channel (PUSCH) transmission occasions of a multi-PUSCH configured grant (CG) cycle can be blocked by one or more CG timers running for HARQ PIDs that correspond to the one or more PUSCH transmission occasions, wherein the HARQ PIDs were determined based on a default method;
changing a respective HARQ PID corresponding to at least one of the one or more PUSCH transmission occasions to a respective alternate HARQ PID, in response to determining that the one or more PUSCH transmission occasions can be blocked by the one or more CG timers; and
performing uplink (UL) communications based at least on the changed respective HARQ PID.

15. The non-transitory memory element of claim 14, the operations further comprising:
determining whether a HARQ PID corresponding to at least one of the one or more PUSCH transmission occasions is to be changed to a respective alternate HARQ PID, based at least on whether the at least one of the one or more PUSCH transmission occasions is already indicated to be an unused transmission occasion (UTO) or an invalid PUSCH transmission occasion (ITO).

16. The non-transitory memory element of claim 14, the operations further comprising:
determining whether a HARQ PID corresponding to at least one of the one or more PUSCH transmission occasions is to be changed to a respective alternate HARQ PID a specified number, N>=1, times.

17. The non-transitory memory element of claim 14, the instructions further comprising:
performing the determining and the changing until none of the determined corresponding HARQ PIDs associated with PUSCH transmission occasions of the one or more PUSCH transmission occasions not identified as unused transmission occasions (UTOs) or invalid PUSCH transmission occasion (ITOs) are blocked by a running CG timer.

18. The non-transitory memory element of claim 14, wherein changing the respective HARQ PID comprises using a second method different from the default method.

19. The non-transitory memory element of claim 18, wherein the default method comprises:
assigning a value to a first HARQ PID; and
obtaining each following HARQ PID by incrementing, by a specified value Y, an immediately preceding HARQ PID, until all the corresponding HARQ PIDs have been determined.

20. The non-transitory memory element of claim 19, wherein the second method comprises obtaining the respective alternate HARQ PID by incrementing, by a specified value Y′ different from the specified value Y, an immediately preceding HARQ PID; and
the operations further comprising indicating, to a base station, the specified value Y′.
